(19) United States
(12) Patent Application Publication
(10) Pub. No.: US 2025/0378023 A1
(43) Pub. Date: Dec. 11, 2025

(54) Hybrid Logical to Physical Address Mapping

(71) Applicant: Marvell Asia Pte, Ltd., Singapore (SG)

(72) Inventors: Anh Nguyen, Ho Chi Minh City (VN); Son Le, Ho Chi Minh City (VN); Hiep Nguyen, Ho Chi Minh City (VN)

(73) Assignee: Marvell Asia Pte, Ltd., Singapore (SG)

(21) Appl. No.: 19/063,221

(22) Filed: Feb. 25, 2025

Related U.S. Application Data
(60) Provisional application No. 63/658,651, filed on Jun. 11, 2024.

(51) Int. Cl. G06F 12/02

(52) U.S. Cl. CPC G06F 12/0246; G06F 2212/7201

(57) ABSTRACT

The present disclosure describes apparatuses and methods for hybrid logical to physical (LTP) address mapping in memory systems. In various aspects, a memory controller maps, with an interleave map mode, a first portion of logical address space to a first portion of the physical address space of a memory. The memory controller also maps, with a fixed map mode, a second portion of logical address space to a second portion of the physical address space of the memory. Thus, the memory controller may configure some memory banks with interleave address mapping and other banks with fixed address mapping. In some cases, the memory controller may reconfigure a bank of the memory from one mapping mode to the other mapping mode. By so doing, the memory controller can leverage benefits provided by either mapping mode to optimize access performance, reduce power consumption, or isolate defective areas with minimal capacity loss.

### CROSS REFERENCE TO RELATED APPLICATION

This present disclosure claims priority to U.S. Provisional Patent Application Ser. No. 63/658,651 filed Jun. 11, 2024, the disclosure of which is incorporated by reference herein in its entirety.

### BACKGROUND

Many computing and electronic devices include memory for storing an operating system, applications, or data of the device. Over time, increasing device complexity and data processing needs have placed greater demands on the memory of a device. To address these demands, some system designers use on-chip memory, which is placed within a chip to reduce latency and improve performance. On-chip memories, however, typically serve multiple clients within the chip that may attempt to access the on-chip memory at the same time. This concurrent access can result in collisions as the clients request access to the same area of memory, which increases latency and reduces access performance of the memory. Additionally, data distribution patterns within the on-chip memory may prevent the memory from entering a power save mode because one active client may attempt to access data located throughout the memory. These data distribution patterns may also result in the on-chip memory losing an entire block of memory when a small defect is detected because data cannot be written to addresses around the defective area. As such, preceding on-chip memory designs may suffer from impaired performance due to collisions, consume excess power while clients are inactive, and lose excessive capacity when memory defects are isolated.

### SUMMARY

This summary is provided to introduce subject matter that is further described in the Detailed Description and Drawings. Accordingly, this Summary should not be considered to describe essential features nor used to limit the scope of the claimed subject matter.

In some aspects, a method configuring logical to physical mapping of a memory with multiple banks includes mapping, with an interleave map mode, a first portion of logical address space to a first portion of physical address space of the multiple banks of the memory. The method also maps, with a fixed map mode, a second portion of the logical address space to a second portion of the physical address space of the multiple banks of the memory. The method includes routing, in accordance with the interleave map mode, commands for the first portion of the logical address space to the first portion of the physical address space based on a boundary between the first portion of the physical address space and the second portion of the physical address space. The method also routes, in accordance with the fixed map mode, other commands for the second portion of the logical address space to the second portion of the physical address space, based on the boundary between the first portion of the physical address space and the second portion of the physical address space.

In other aspects, an apparatus configured to implement hybrid logical to physical memory mapping includes a host interface configured for communication with a host and a media interface configured to enable access to the storage media. The apparatus also includes a processor core configured to execute instructions to manage transfers of data of the host between the host interface and the media interface and a memory configured to store the data of the host and data of the processor core. A memory controller of the apparatus is configured to map, with an interleave map mode, a first portion of logical address space exposed to the host interface and the processor core to a first portion of physical address space of multiple banks of the memory. The memory controller is also configured to map, with a fixed map mode, a second portion of the logical address space exposed to the host interface and the processor core to a second portion of the physical address space of the multiple banks of the memory. The memory controller can route, in accordance with the interleave map mode, commands for the first portion of the logical address space to the first portion of the physical address space based on a boundary between the first portion of the physical address space and the second portion of the physical address space. The memory controller may also route, in accordance with the fixed map mode, other commands for the second portion of the logical address space to the second portion of the physical address space based on the boundary between the first portion of the physical address space and the second portion of the physical address space.

In yet other aspects, a System-on-Chip (SoC) configured to implement hybrid logical to physical memory mapping includes a component configured to implement a function of the SoC and a processor core configured to execute instructions to manage operation of the SoC. The SoC also includes a memory system with a first port configured to enable communication with the processor, a second port configured to enable communication with the component, and a memory configured to store data of the component and data of the processor core. A memory controller of the SoC can configure a map mode pointer to separate a first region of physical address space of the memory (e.g., a first subset of banks) from a second region of physical address space of the memory (e.g., a second subset of banks). The memory controller can then map, with an interleave map mode, a first portion of logical address space exposed to the first port and the second port to the first region of physical address space of the memory, and map, with a fixed map mode, a second portion of the logical address space exposed to the first port and the second port to the second region of the physical address space of the memory. When a command is received from the component via the first port or the processor core via the second port for access to the memory based on a logical address, the memory controller determines, based on the map mode pointer and the logical address of the command, to route the command to the first region of the physical address space or the second region of the physical address space. The memory controller then routes the command to the first region of the physical address space of the memory or routes the command to the second region of the physical address space of the memory.

The details of one or more implementations are set forth in the accompanying drawings and the following description. Other features and advantages will be apparent from the description and drawings, and from the claims.

### BRIEF DESCRIPTION OF THE DRAWINGS

The details of one or more implementations of hybrid logical to physical address mapping for memory systems are set forth in the accompanying figures and the detailed description below. In the figures, the left-most digit of a reference number identifies the figure in which the reference number first appears. The use of the same reference numbers in different instances in the description and the figures indicates like elements:

FIG. 1 illustrates an example operating environment having systems in which various aspects of hybrid logical to physical (LTP) address mapping can be implemented;

FIG. 2 illustrates an example configuration a solid-state drive with a memory controller that can implement one or more aspects of hybrid LTP address mapping;

FIG. 3 illustrates an example implementation of an on-chip memory system in which various aspects of hybrid LTP address mapping can be implemented;

FIG. 4 illustrates an example hybrid LTP address map implemented with a pointer in accordance with one or more aspects;

FIG. 5 illustrates example configurations of low-power address mappings implemented in accordance with one or more aspects;

FIG. 6 illustrates an example of remapping a bank of memory without data movement in accordance with one or more aspects;

FIG. 7 illustrates another example of reconfiguring a map mode pointer to change a map mode of a bank of memory in accordance with one or more aspects;

FIG. 8 illustrates an example of remapping a defective bank of interleave mapped memory with a fixed map mode to enable continued use of the bank;

FIG. 9 illustrates an example implementation of configurable error detection and correction (EDAC) in accordance with various aspects;

FIG. 10 illustrates example pointer configurations for implementing hybrid LTP address mapping with configurable EDAC in accordance with one or more aspects;

FIG. 11 depicts an example method for implementing hybrid LTP address mapping in accordance with one or more aspects;

FIG. 12 depicts an example method for configuring regions of physical address space through different respective types of mapping modes;

FIG. 13 depicts an example method for configuring instances of a memory bank for operation in a low-power mode in accordance with one or more aspects;

FIG. 14 depicts an example method for remapping a bank of memory with a different map mode in accordance with one or more aspects;

FIG. 15 depicts an example method for implementing configurable EDAC in a memory address space implemented through multiple map modes;

FIG. 16 illustrates an example System-on-Chip (SoC) environment in which aspects of hybrid LTP address mapping can be implemented; and

FIG. 17 illustrates an example storage system controller in which aspects of hybrid LTP address mapping can be implemented.

### DETAILED DESCRIPTION

Computing systems and components often include memory for storing data associated with an operating system, firmware, applications, or services of the system or component. With ever-increasing data processing, communication, and storage demands, many system designers are using on-chip memory (OCM), which is placed within a chip of a system or device to reduce latency and improve performance. Generally, OCM performs better and consumes less power than equivalent off-chip memory solutions. Further, with process scaling, more static random-access memory (SRAM) can be integrated into a chip to achieve higher performance, such that storage controllers, storage accelerators, data processing unit, artificial intelligence (AI) accelerator, and the like may include hundreds of megabytes of OCM.

Multiple components or initiators of a system often share an OCM, which requires an efficient memory controller to manage access to the OCM without compromising performance. In an OCM controller, physical memory circuits (e.g., memory devices, memory dies) are typically divided into multiple memory banks to increase memory performance. As the size or capacities of on-chip memories increase, power consumption also rises at a commensurate rate. Thus, the memory controller should attempt to optimize power consumption while efficiently managing access to the OCM.

Further, with the integration of higher OCM density using smaller transistors, the likelihood of soft errors (e.g., neutron or alpha particle strikes) and/or hard errors (e.g., aging, wear-out) increases over the lifetime of the chip. In critical applications, such as data center or automotive, the controller must be able to detect and remove memory locations with a high probability of soft errors and/or hard errors to prevent data loss. This can improve reliability and extend the lifetime of the chip at the expense of reduced usable memory capacity and may potentially lower performance. To implement these features, an OCM controller typically maps an “initiator” address to a physical memory address, the implementation of which can be critical for performance, power consumption, and the lifetime of a chip in which the OCM is integrated. In other words, the memory controller needs to have a process to map a logical or virtual address of an initiator to a physical address of the memory in the OCM controller. Thus, performance of the OCM can be impaired when a memory controller fails to efficiently map the logical addresses of the initiators to the physical addresses of OCM.

This disclosure describes apparatuses and techniques for hybrid logical to physical address mapping for memory systems. In contrast with preceding techniques of address mapping, the apparatuses and techniques described may implement hybrid logical to physical (LTP) address mapping in which a logical address space of initiators is mapped using multiple mapping types or modes, which can enable a memory controller to use respective advantages of each map mode to optimize memory performance. For example, to accelerate access from multiple initiators to banks of OCM, a memory controller can map the logical or virtual addresses from initiators to the memory banks in an “interleaved” fashion (e.g., interleave map mode). Alternatively, the memory controller can map the logical addresses from the initiators to the memory banks using a “fixed” configuration (e.g., fixed map mode). As such, in an example configuration of a 16-megabyte (16-MB) memory organized into 16 1-MB banks, a preceding memory controller could implement one of these types of address mapping.

In the context of this example, using an interleave map mode (IMM), the memory controller can distribute four kilobytes (4 KB) memory accesses from multiple initiators across all 16 memory banks, which reduces collision probability and may achieve higher performance than a fixed map mode (FMM) in which the controller only maps a 4 KB access into one bank. As such, the IMM may provide better performance than the FMM when the memory is used as a first-in, first-out (FIFO) buffer for the 4 KB accesses. Specifically, when using the IMM in a memory system with multiple initiators (e.g., 4-8 initiators), users can utilize more total bandwidth of the initiators than in the FMM because accesses are distributed across memory banks, yet bank collision probability is not zero because it is impossible for the users to control collisions. Some restrictions related to using the IMM are that among interleaved banks or regions, the size of the banks or regions must be equivalent (e.g., 16 1 MB banks). Further, when a defect is identified within a bank or region of interleaved memory during operation, the entire bank or region has to be removed from the logical address space. This can significantly reduce the amount of usable memory capacity and potentially degrade overall system performance.

Turning to the FMM, if the logical address range of each initiator is mapped to a corresponding physical address range, such as initiator 0 to a 0-1 MB physical address range, initiator 1 to a 1 MB-2 MB physical address range, and so on, bank collisions from multiple initiator accesses can be eliminated, which may result in full utilization of initiator bandwidth. In other words, users can control or avoid collisions under the FMM. Another advantage of the FMM is that the respective size of each bank or region mapped can be different. For example, if a defect is identified at a specific location within a bank, the memory controller can still use a portion of the bank or all remaining memory within the bank. Thus, the FMM may enable the memory controller to work around defects within the memory banks and extend the life of a system with less capacity loss. The FMM may also provide power advantages in that initiators are mapped to specific physical address ranges such that when an initiator is inactive, the corresponding physical memory may be put in a low-power mode. For example, when only the 14 MB-16 MB address range is being used, banks #14 and #15 are left active and all other banks of the memory can be put in a low-power state. In summary, there are respective performance, power, defect mitigation, and lifetime trade-offs with interleave and fixed map modes, and employing only one map mode is not optimal for most memory applications.

In various aspects of hybrid LTP address mapping, a memory controller of a memory system (e.g., OCM) can map, with an IMM, a first portion of the logical address space exposed to initiators to a first portion of the physical address space (e.g., banks) of a memory. The memory controller also maps, with a FMM, a second portion of the logical address space to a second portion of the physical address space (e.g., other banks) of the memory. Thus, the memory controller may configure some banks of the memory with interleave address mapping and other banks with fixed address mapping. The memory controller may maintain a map mode pointer that is configured to set or maintain the portions of physical address space to which the different map modes apply. In various aspects, the memory controller may also use the hybrid LTP address mapping to implement low-power modes, bank remapping, defect isolation, configurable error detection and correction, or the like. For example, the memory controller may identify a defective or error-prone area of a memory bank and remap that memory bank to a physical address using a FMM to enable continued use of the rest of the memory bank that is not defective. By so doing, the memory controller can leverage benefits provided by either mapping mode to optimize access performance, reduce power consumption, or isolate defective areas with minimal capacity loss.

By way of example and in the context of a 16-MB memory organized into 16 1-MB banks, the firmware of the memory controller can map 14 banks (banks #0-#13) with the IMM for use as data buffers for processing input/output (I/O) commands of a storage controller. The firmware can map the remaining two 1 MB banks (banks #14 and #15) with the FMM to store the firmware and/or software code and respective data of two processor cores of the storage controller. Each of the processor cores can be mapped to a respective one of the banks to ensure zero bank collisions between the accesses of the processor cores. When the storage controller enters a sleep or low-power mode, the 14 banks mapped in IMM (banks #0-#13) can be placed in the lowest possible power-saving mode (e.g., deep sleep, shutdown), while banks #14 and #15 remain in an active or retention state to store the firmware and software code that the processor cores can access to process administration commands (admin commands) from a host coupled with the storage controller. In response to the detection of an admin command, the firmware and/or software executing on the processor cores can bring the other 14 banks out of the power-saving mode, enabling them for use as data buffers for processing data of I/O commands of the storage controller. By implementing aspects of hybrid LTP address mapping, the 14 banks mapped in interleave mode can be powered down, resulting in a reduction of power consumption of up to 80 percent.

In some aspects, instances of memory within a bank may be selectively configurable for low-power operation. For example, one 1-MB bank (e.g., bank #15) may be configured to operate using the FMM and may be organized into eight 0.125 MB instances, four of which being configurable for parallel (256b) accesses or sequential accesses (64b). When only 0.5 MB of memory is required to be active during a low-power mode, users or the firmware may keep instances #0-#3 active, while instances #4-#7 are placed in the low power mode. If less than 0.5 MB memory is required in low-power mode, the user (e.g., host management application) or firmware can power down additional 0.125-MB instances. With this low-power mapping configuration, the hybrid LTP address mapping allows only instance #0 to remain active for 0.125 MB of available memory and the other seven instances can be placed in the low-power mode to maximize power conservation.

In other aspects, such as when configured for increased performance, banks #0-#13 can be configured in IMM and banks #14-#15 can be configured in FMM. When performance requirements of the memory controller are lower, however, the system or firmware may identify that only 12 banks are needed for buffering data of the I/O commands. In this case, the firmware can dynamically reconfigure or adjust a map mode pointer to move two banks (e.g., banks #12 and #13) to the FMM portion of the physical memory and then place those banks in a low-power state. In other words, the firmware can dynamically reallocate banks to the fixed map region to reduce power consumption.

Alternatively or additionally, when the firmware or software of the controller needs additional storage for code or data (and has unused buffer memory), the firmware can adjust the map mode pointer to add another bank (e.g., bank #13) of the memory to the FMM portion of physical memory for use by the processor cores. Thus, the firmware can dynamically adjust the map mode pointer to reconfigure the number of the banks mapped in interleave mode and the number of banks mapped in fixed mode to optimize memory performance for the given needs of the storage controller. In some implementations, the memory controller may also include bank remapping logic, which can operate in conjunction with hybrid LTP address mapping. This may enable the firmware to minimize data movements between locations when reconfiguring or adjusting the map mode pointer. For example, when a bank in IMM is identified as defective, a user or the firmware can use remapping to effectively swap the bank with the defect with another functional bank in the FMM to minimize any impact on performance and maximize the remaining usable memory space of the bank with the defect. These are but a few examples of how aspects of hybrid LTP address mapping may be implemented to improve memory performance, which are further described throughout the disclosure.

The following discussion describes an operating environment, techniques that may be employed in the operating environment, and a System-on-Chip (SoC) in which components of the operating environment may be embodied. In the context of the present disclosure, reference is made to the operating environment or various components by way of example only.

### Operating Environment

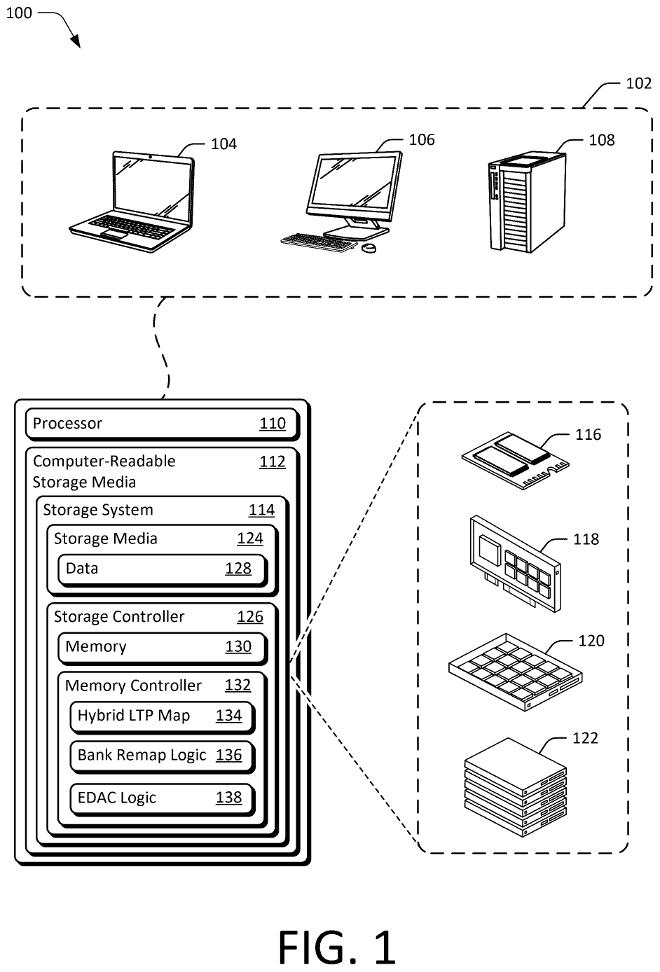

FIG. 1 illustrates an example operating environment 100 having a host system 102, capable of processing, storing, or accessing various forms of data or information. Examples of a host system 102 may include a laptop computer 104, desktop computer 106, and server 108, any of which may be configured as a user device, computing device, or as part of a storage network, data storage center, cloud storage, or the like. Further examples of host system 102 (not shown) may include a tablet computer, a set-top-box, a data storage appliance, wearable smart-device, television, content-streaming device, high-definition multimedia interface (HDMI) media stick, smart appliance, home automation controller, smart thermostat, Internet-of-Things (IoT) device, mobile-internet device (MID), network-attached-storage (NAS) drive, aggregate storage system, gaming console, automotive entertainment device, automotive computing system, automotive control module (e.g., engine or power train control module), and so on. Generally, the host system 102 may process, communicate, or store data for any suitable purpose, such as to enable functionalities of a particular type of device, provide a user interface, enable network access, implement gaming applications, playback media, provide navigation, edit content, provide data storage, or the like.

The host system 102 includes a processor 110 and computer-readable media 112. The processor 110 may be implemented as any suitable type or number of processors, either single-core or multi-core, for executing instructions or commands of an operating system or other applications of the host system 102. In aspects, the processors 110 of a host system may execute tenants, services, or workloads of a data storage system or data storage center. The computer-readable media 112 (CRM 112) includes memory (e.g., host memory, not shown) and a storage system 114 of the host system 102. The memory of the host system 102 may include any suitable type or combination of volatile memory or nonvolatile memory. For example, the volatile memory of the host system 102 may include various types of random-access memory (RAM), dynamic RAM (DRAM), static RAM (SRAM), or the like. The non-volatile memory may include read-only memory (ROM), electronically erasable programmable ROM (EEPROM), solid-state storage media, or Flash memory.

The storage system 114 of the host system 102 may be configured as any suitable type of data storage system, such as a data storage center, storage device, storage drive, storage array, storage volume, or the like. Although described with reference to the host system 102, the storage system 114 may also be implemented separately as a standalone device or as part of a larger storage collective, such as a network-attached storage device, external storage drive, data storage center, server farm, or virtualized storage system (e.g., for cloud-based storage or services). Examples of the storage system 114 include a non-volatile memory express (NVMe) solid-state drive 116, a peripheral component interconnect express (PCIe) solid-state drive 118, a solid-state drive 120 (SSD 120), and a storage array 122, which may be implemented with any combination of storage devices or storage drives.

The storage system 114 includes storage media 124 and a storage media controller 126 (storage controller 126) for managing various operations or functionalities of the storage system 114. The storage media 124 may include or be formed from non-volatile memory devices on which data 128 or information of the host system 102 is stored. The storage media 124 may be implemented with any type or combination of solid-state memory media, such as Flash, NAND Flash, RAM, DRAM (e.g., for caching), SRAM, or the like. For example, the storage media 124 of the storage system 114 may include NAND Flash memory, single-level cell (SLC) Flash memory, multi-level cell (MLC) Flash memory, triple-level cell (TLC) Flash, quad-level cell Flash (QLC), NOR cell Flash, or any combination thereof. These memories, individually or in combination, may store data associated with a user, applications, tenant, workload, service, and/or an operating system of the host system 102.

Generally, the storage controller 126 manages operation of the storage system 114 and enables the host system 102 to access the storage media 124 for data storage. The storage controller 126 may be implemented through any suitable combination of hardware, firmware, or software to provide various functionalities of the storage system 114. In some cases, the storage controller 126 and/or firmware of the storage controller implement power management for the storage system 114 and/or components of the storage system. The storage controller 126 may also manage or administrate internal tasks or operations associated with the storage media 124, which may include data placement, data-to-block mapping, data caching, data migration, garbage collection, thermal management (e.g., throttling), power management, or the like. As such, the storage controller 126 may receive various commands from the host system 102, which may include administrative commands (admin commands) for system configuration or power management functions, or I/O commands for data transfers. Alternatively or additionally, the storage controller may receive I/O commands for data access and queue (or generate) I/O commands associated with internal operations for the storage media 124. In some cases, the storage controller 126 may perform media I/Os for access of the storage media 124 that correspond to the host I/O commands for data access (e.g., host write requests or read requests) and/or internal I/Os for internal operations or tasks associated with the storage media 124.

In this example, the storage controller 126 also includes a memory 130 (e.g., OCM) and a memory controller 132 (e.g., OCM controller) with a hybrid LTP address map 134 (hybrid LTP map 134), bank remap logic 136, and error detection and correction logic 138 (EDAC logic 138). In other configurations, the memory controller 132 may be coupled with or have access to a hybrid LTP address map 134, bank remap logic 136, or EDAC logic 138, any of which may be implemented separately from the memory controller 132. In various aspects, the hybrid LTP address map 134 includes mapping logic that supports IMM and FMM boundaries that are configurable to enable hybrid LTP address mappings in which a logical address space of initiators can be mapped to portions or regions of physical address space of the memory 130 using the respective interleave and fixed mode mappings. The bank remap logic 136 of the memory controller 132 can be configured to remap a range of logical addresses from one memory bank to another memory bank. In some cases, the bank remap logic 136 can remap a bank of memory between map mode regions, such as remapping an interleave mapped bank from the interleave region to the fixed mode region for fixed mode mapping. For example, in a 16 MB memory of 1 MB banks, the bank remap logic 136 can remap bank #13 supporting interleave mapping from a logical address of D0_0000-DF_FFFF to a logical address of F0_0000-FF_FFFF where the remapped bank then supports fixed mode mapping.

The EDAC logic 138 may be configured to implement different types of error correction code (ECC), such as single-bit error correction and double-bit error detection (SECDEC), over different portions or regions of logical address space based on boundaries between the different ECC address spaces. For example, a memory controller may implement a map mode pointer (e.g., interleave pointer) to define address regions with different mapping modes and an ECC pointer to define other address regions with different SECDEC configurations. The respective regions of the different mapping modes and different SECDEC configurations may align or overlap in accordance with various aspects of hybrid LTP address mapping. These are but a few examples of how the aspects of hybrid LTP address mapping can be implemented, which are further described throughout the disclosure.

Although not shown, the host system 102 may also include I/O ports, a graphics processing unit (GPU), and data interfaces. Generally, the I/O ports allow a host system 102 to interact with other devices, peripherals, or users. For example, the I/O ports may include or be coupled with a universal serial bus, human interface devices, audio inputs, audio outputs, or the like. The GPU processes and renders graphics-related data for host system 102, such as user interface elements of an operating system, applications, or the like. In some cases, the GPU may include OCM that is implemented as described with reference to memory 130 and memory controller 132 of the storage controller 126 of FIG. 1. For example, a GPU may be implemented with an OCM that implements various aspects of hybrid LTP address mapping.

The data interfaces of the host system 102 provide connectivity to one or more networks and other devices connected to those networks. The data interfaces may include wired interfaces, such as Ethernet or fiber optic interfaces for communicating over a local network, intranet, or the Internet. Alternatively or additionally, the data interfaces may include wireless interfaces that facilitate communication over wireless networks, such as wireless LANs, wide-area wireless networks (e.g., cellular networks), and/or wireless personal-area-networks (WPANs). Any of the data communicated through the I/O ports or the data interfaces may be written to or read from the storage system 114 of the host system 102 through the memory of the storage controller 126 in accordance with one or more aspects of hybrid LTP address mapping.

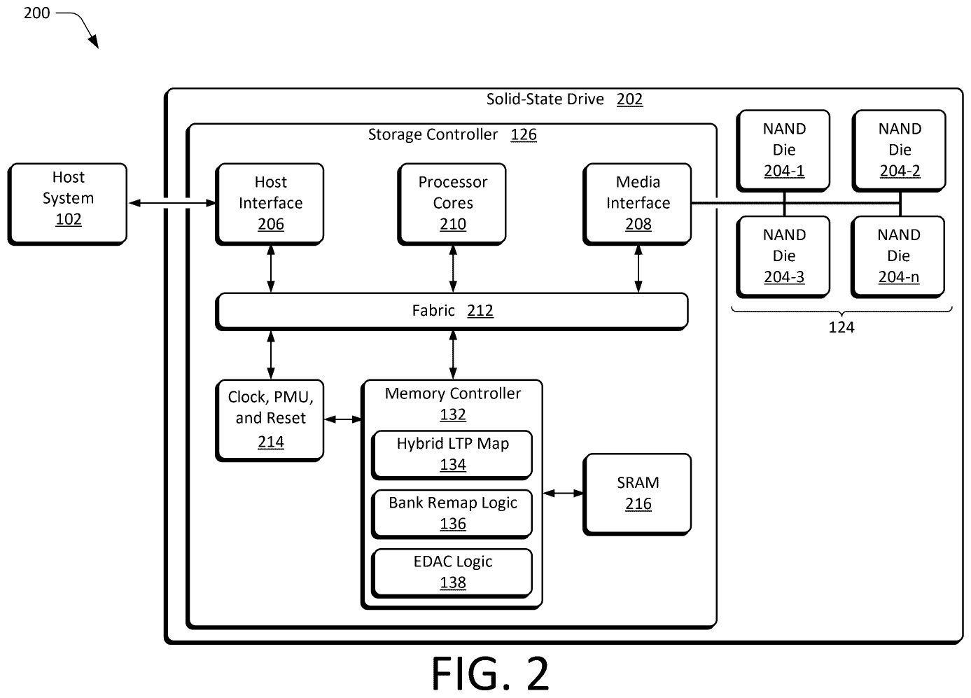

FIG. 2 illustrates at 200 an example configuration of a solid-state drive (SSD) with a memory controller that can implement one or more aspects of hybrid LTP address mapping. In this example, an SSD 202 includes an instance of a storage controller 126 with a memory controller 132, which may manage an internal memory (e.g., SRAM) of the storage controller using hybrid LTP address mapping and other aspects described herein. Generally, the memory controller 132 may manage access to the internal memory of the storage controller by a processor or other initiators of the storage controller to process various commands of a host system 102 or firmware executing on the processor to implement functionalities of the storage controller. Although described in the context of a storage controller, the aspects of hybrid LTP address mapping may be implemented by a memory controller implemented in any suitable device, such as a storage accelerator, storage switch, network switch, data processing unit, artificial intelligence (AI) accelerator, or the like.

In this example, the memory controller 132, hybrid LTP address map, bank remap logic 136, and EDAC logic 138 are illustrated in the context of a storage system implemented as an SSD 202. The SSD 202 may be coupled to any suitable host system 102 and implemented with storage media 124, which in this example includes multiple NAND Flash dies 204-1 through 204-n, where n is any suitable integer. In some cases, the NAND dies 204 form a NAND device that includes multiple Flash channels of memory devices, dies, or chips. Operations and/or functions of the SSD 204 are enabled or managed by an instance of the storage controller 126, which in this example includes a host interface 206 to enable communication with the host system 102 and a media interface 208 to enable access to the storage media 124 (e.g., NAND device). The host interface 206 may be configured to implement any suitable type of storage interface or protocol, such as serial advanced technology attachment (SATA), universal serial bus (USB), PCIe, advanced host controller interface (AHCI), non-volatile memory express (NVMe), NVM-over Fabric (NVM-OF), NVM host controller interface specification (NVMHCIS), small computer system interface (SCSI), serial attached SCSI (SAS), secure digital I/O (SDIO), Fibre channel, any combination thereof (e.g., an M.2 or next generation form-factor (NGFF) combined interface), or the like. Alternately or additionally, the media interface 208 may implement any suitable type of storage media interface, such as a Flash interface, Flash bus channel interface, NAND channel interface, physical page addressing (PPA) interface, or the like.

When communicating in accordance with an NVMe, the host system 102 and storage controller 126 may communicate various commands to data transfers, device configuration, power management, or the like. For example, the commands may include administrative commands (admin commands) for controller management, system configuration, or power management. Alternatively, input/output (I/O) commands relate to data transfers, for which the host interface 206 and/or the storage controller 126 may receive, process, and/or generate corresponding data/storage commands. These data/storage commands may include host I/Os for moving host data, internal I/Os for internal operations (e.g., housekeeping, garbage collection), or media I/Os that are issued to the NAND storage device to implement corresponding data movement. Generally, the components of the SSD 202 or storage controller 126 provide a data path between the host interface 206 to the host system 102 and the media interface 208 to the storage media 124. In this example, the storage controller 126 includes processor cores 210 for executing a kernel, firmware, or a driver to implement various functions of the storage controller 126.

As shown in FIG. 2, a fabric 212 of the storage controller 126, which may include control and data channels/buses, operably couples and enables communication between the components of the storage controller 126. For example, the firmware executed on the processor cores 210 may communicate with and/or transfer data between the host interface 206, media interface 208, memory controller 132, and/or a clock, power management unit (PMU), and reset block 214 of the storage controller to exchange commands, settings, data, information, or I/Os within the storage controller 126. Although shown separately from the memory controller 132, the PMU or similar power management logic may be embedded within the memory controller. In various implementations, the storage controller 126 includes a memory for buffering data, storing data, and/or storing processor-executable instructions or code for firmware or drivers of the storage controller. In this example, the storage controller 126 includes SRAM 216, which is accessible through the memory controller 132, for buffering data and storing data and processor-executable instructions or code (e.g., firmware) executed by processor cores 210 to implement the various operations and functions of the storage controller 126. For example, the storage controller 126 may use the SRAM 216 for buffering or caching data as the storage controller 126 moves data between the host system 102, storage media 124 (e.g., NAND device), or other components of the storage controller.

In some aspects, the clock, PMU, and reset block of the storage controller 214 implements various operations to alter power consumption of the storage controller 126. For example, the host system 102 or firmware of the storage controller 126 can use NVMe admin commands to implement power management, such as by supporting autonomous power state transitions (APST) that allow an NVMe device to automatically transition between power states without host intervention. Thus, the firmware of the storage controller can autonomously determine an optimal power state or component settings based activity of the storage controller to enhance power efficiency. Based on a determined power state (e.g., low-power state), the storage controller 126 and/or firmware may use the PMU, via a power interface of the memory controller 132, to configure or set a power state of the memory controller 132 and the SRAM 216. Alternatively or additionally, the PMU can power down and/or reduce clock frequencies to components of the storage controller in low-power modes. Thus, the memory controller 132 may interact with the PMU to implement various aspects of low-power modes in the context of hybrid LTP address mapping, examples of which are described throughout the disclosure.

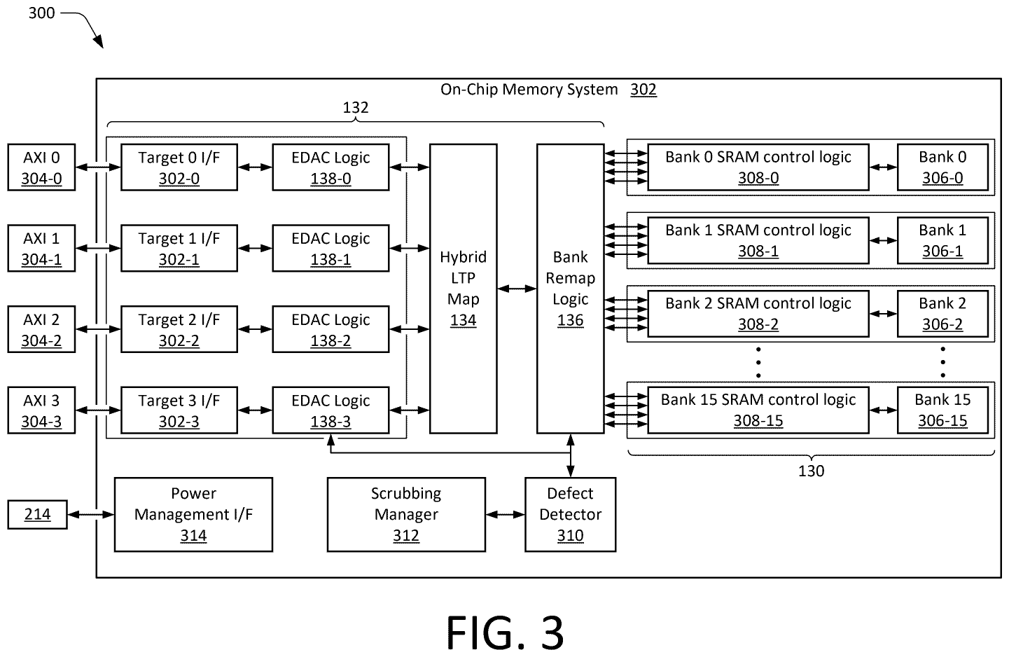

FIG. 3 illustrates at 300 an example implementation of an OCM system in which various aspects of hybrid LTP address mapping can be implemented. In this example, a memory controller 132 and memory 130 are embodied as part of an on-chip memory (OCM) system 302, which can be implemented as part of any suitable integrated circuit or embedded system (e.g., system-on-chip). When implemented as an OCM system, the memory controller 132 of the OCM system or module may include an interface configured to communicate with a fabric or interconnect of a system in which the OCM is embedded. Although not shown, the OCM system 302 may also include a memory initialization manager, block and memory built-in self-test (MBIST) interface, and/or a register file interface for configuration over an advanced peripheral bus (APB).

As shown in FIG. 3, a communication interface of the memory controller 132 can be configured as multiple AXI target interfaces 302-0 through 302-3, though the communication interface may be configured with any suitable number of target interfaces 302 (e.g., 8 target interfaces, 16 target interfaces). One or more initiators of the system may be configured to communicate with one of the AXI target interfaces 302 of the OCM system 302 via a respective AXI port 304-0 through 304-3. For example, an NVMe interface controller can be mapped to AXI port 0 304-0, an NVMe controller memory buffer can be mapped to AXI port 1 304-1, and a processor core of a storage controller can be mapped to AXI port 2 304-2.

Generally, the AXI target interfaces 302 of the memory controller 132 can convert various AXI read requests and/or write requests from the initiators into respective memory read requests and/or write requests for the memory 130. As shown in FIG. 3, the memory 130 of this example OCM system 302 includes sixteen banks of SRAM 306-0 through 306-15, which are operably coupled with components of the memory controller 132 via respective instances of SRAM control logic 308-0 through 308-15. For each target interface 302, an instance of the EDAC logic 138-0 through 138-3 can perform ECC code generation and/or error checking for data associated with the requests. The memory controller 132 may implement a hybrid LTP address map 134 to perform address mapping to route, direct, or steer the memory requests to targeted physical memory banks of the request. As described herein, the hybrid LTP address map 134 may be configured to map the request to the memory banks using an interleave map for a first subset of the memory banks and a FMM for a second subset of the memory banks. The memory controller 132 also includes bank remap logic 136, which may be configured to remap the memory requests to different ones of the memory banks of the OCM system 302.

In some aspects, the bank remap logic 136 is configured as a lookup table for mapping logical address ranges to different physical address ranges that correspond to the SRAM banks 306. For example, in the context of a memory organized into 16 banks, the bank remap logic may be implemented as a 16×4 D flip-flop-based lookup table (DFF-based LUT), which may require only a small amount of silicon area and operate quickly. A DFF-based lookup table of bank remap logic may also scale efficiently, with a 128×7 lookup table being capable of remapping a memory of 128 banks. In some implementations, the bank remap logic 136 is coupled with a defect detector 310 of the OCM system 302 to assist the firmware in identifying defects, which can then use the bank remap logic 136 to remap a defective memory bank. For example, the defect detector 310 may communicate with the EDAC logic 138 and/or a scrubbing manager 312 of the OCM system 302 to identify cells or areas of a memory bank that are defective.

Specifically, the EDAC logic 138 may detect errors in relation to data access and/or the scrubbing manager 312 may scan the memory banks for errors, with either configured to provide indications of the errors to the defect detector 310. In some cases, the defect detector 310 is implemented with respective counters (e.g., sticky counters) to count or track 1-bit and/or 2-bit errors, and two respective threshold registers configurable by the firmware to specify threshold values for 1-bit and 2-bit errors. In response to a counter exceeding the threshold value of a corresponding register, the firmware can mark the area or bank of memory as defective. In aspects, the bank remap logic 136 can remap a defective bank to minimize performance impact of the defect and maximize usable memory space when errors (e.g., persistent errors) are detected. The OCM system 302 may also include a power management interface 314 (power management I/F 314) to enable aspects related to managing power states of the memory controller 132. The power management I/F 314 may be coupled with a clock, PMU, and reset block 214 of the storage controller. In some aspects, one or more of the SRAM banks 306 may include a sequencer and instances of memory configured to support low-power address maps as described herein.

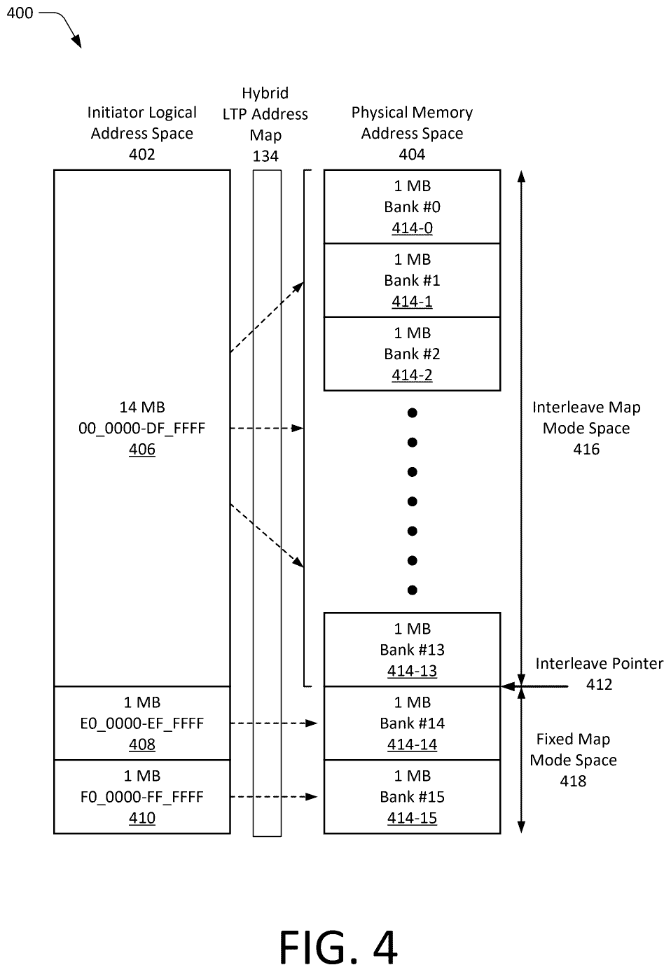

FIG. 4 illustrates at 400 an example hybrid LTP address map implemented with a pointer in accordance with one or more aspects. In various aspects, a memory controller of a memory system (e.g., OCM), implements a hybrid LTP address map that is configurable to map portions of a logical address space to a physical address space with an IMM and a FMM. Thus, the memory controller may configure some banks of the memory with interleave address mapping and other banks with fixed address mapping. In some implementations, the memory controller maintains a map mode pointer to set or maintain the portions of physical address space to which the different map modes apply. In various aspects, the memory controller may also use the hybrid LTP address mapping to implement low-power modes, bank remapping, defect isolation, configurable error detection and correction, or the like.

As shown in FIG. 4, a hybrid LTP address map 134 may be configured to map portions or regions of an initiator logical address space 402 to respective portions of physical memory address space 404 (e.g., SRAM physical address space). In this example, a first portion of the logical address space 406 may be exposed to or configured for use by a first initiator (or set of initiators), a second portion of the logical address space 408 may be exposed to or configured for use by a second initiator, and a third portion of the logical address space 410 may be exposed to or configured for use by a third initiator. In aspects, the memory controller can implement a map mode pointer, interleave pointer 412 in this example, to divide or separate portions of physical memory address space 404 for multiple memory banks 414 into an interleave map mode space 416 (IMM space 416) and a fixed map mode space 418 (FMM space 418). As shown in FIG. 4, the interleave pointer 412 is set to 14 and separates bank #0 through bank #13 for IMM and banks #14 and #15 for FMM. Thus, the memory controller maps, in the IMM, the first portion of logical address space 406 to the physical memory address space 404 of memory bank #0 414-0 through memory bank #13 414-13. As such, multiple initiators assigned to the first portion of address space 406 may access any of the memory banks #0 414-0 through #13 414-13 in interleave fashion. The memory controller maps, in the FMM, the second portion of the logical address space 408 to the physical memory address space for memory bank #14 414-14 and the third portion of the logical address space 410 to the physical memory address space of memory bank #15 414-15.

In some implementations, the memory controller routes or steers commands of the initiators to the memory banks based on an address of the command and the map mode pointer (interleave pointer 412) configured for the physical memory address space. By way of example, the memory controller can implement physical address calculation as shown in Equation 1 in which a bank select and a bank offset are determined for a given logical address (Initiator Address) based on an interleave pointer.
* If Initiator_Address<Interleave_Pointer*Bank Size
Bank select=Initiator_Address MOD Interleave_Pointer
Bank offset=Initiator_Address DIV Interleave_Pointer
* Otherwise
Bank select=Initiator_Address [23:20]
Bank offset=Initiator_Address [19:0]
   Equation 1: Address Calculation with Map Mode Pointer

As illustrated in Equation 1, when a logical address of an initiator is less than the interleave pointer multiplied by the bank size, the memory controller determines the physical memory address (e.g., SRAM address) with modulo and division operations based on the value of the interleave pointer. Otherwise, the memory controller can use the bit values of the initiator address to determine the bank select and bank offset for the physical memory address. Generally, the map mode pointer or interleave pointer can be configured to define or separate the regions of physical memory address space. For example, when the map mode pointer is set to 0, the hybrid LTP address map maps all of the memory banks in fixed mode and when the map mode pointer is set to 16, the hybrid LTP address map maps all of the memory banks in the interleave mode. As another example, when the map mode pointer is set to 15, the hybrid LTP address map maps banks #0 through #14 in interleave mode and maps bank #15 in FMM. In contrast with preceding designs that rely on exclusive-OR (XOR) operations, the above equation implements modulo (MOD) and division (DIV) operations to calculate the physical memory address. With advances in technology node size and clock speed, the modulo and division operations may be implemented in less than a clock cycle, making the difference between the hybrid address space calculation of Equation 1 and the preceding XOR calculations negligible. Further, the XOR calculations in preceding designs did not work when interleave mapping a number of banks not aligned with a power of two (e.g., 18, 19, 20 banks). As such, aspects of hybrid LTP address mapping with interleave and map modes enable flexible and efficient memory address mapping with negligible difference in cost or speed over preceding designs.

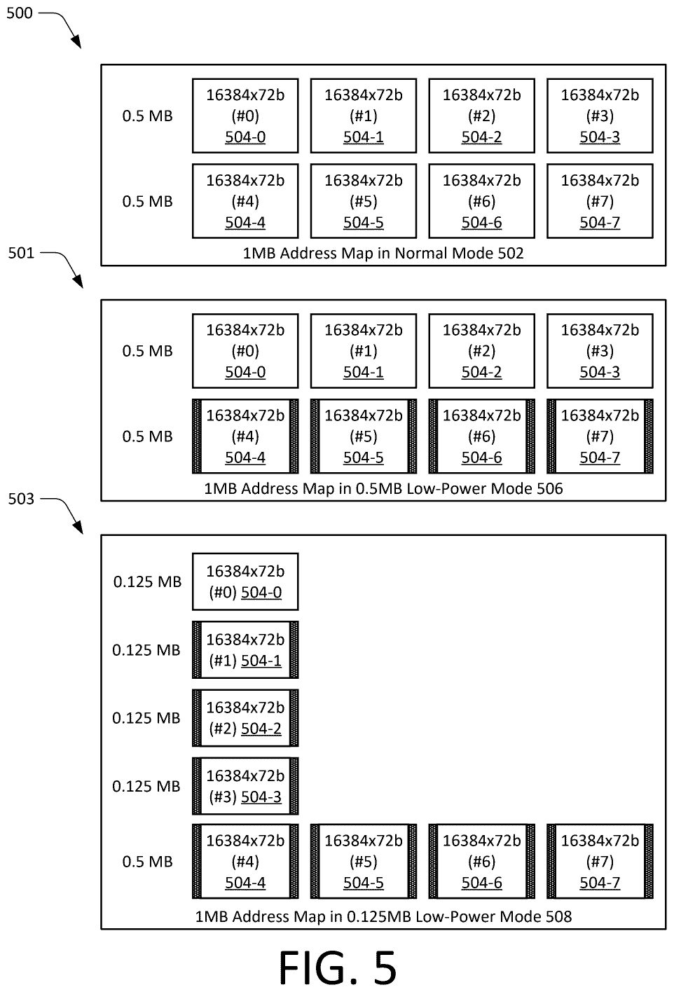

FIG. 5 illustrates at 500, 501, and 503 example configurations of low-power address mappings implemented in accordance with one or more aspects. The examples illustrated at 500, 501, and 503 may represent different configurations or structures of a 1-MB memory bank. In various aspects, the memory controller implements a low-power state in which the controller places a subset of memory banks in a low-power mode while another subset of memory banks remains active for servicing respective initiators. By way of review, when mapped in the IMM, all of the interleaved memory banks may be required to have the same capacity and remain accessible when any one initiator remains active. In the context of the hybrid LTP address mapping of FIG. 4, assume the memory controller assigns banks #0 through #13 in IMM for use as a FIFO buffer for data transfers between the host system and the storage media, and assigns banks #14 and #15 to respective processor cores in FMM for storing firmware and data of the processors. When the host system 102 and/or the storage controller 126 coordinates with the memory controller 132 to enter a low-power state, such as when the storage system is idle or in a sleep mode, the memory controller may place the interleave mode mapped banks #0 through #13 in a low-power mode (e.g., deep sleep or off) and one of the fixed mode mapped banks #14 in a low-power state as well. As such, one of the memory banks, bank #15, may remain active to enable firmware to execute on the processor core to manage operations related to implementing the low-power state and monitor the storage controller for notifications to exit the low-power state. In the following discussion of low-power states, assume banks #0 through #14 are in a low-power state and the controller implements one or more aspects of low-power through bank #15.

In various aspects, one of the memory banks, such as bank #15, may be configured for low-power operation, with configurable instance of memory area and a sequencer that is configured to enable sequential or parallel access to instances of the memory. As shown in FIG. 5, in a normal mode 502, subsets of four instances 504 of memory area (16,384×72b) may be configured for access in parallel (256b) to provide two 0.5 MB memories. In other words, instance #0 504-0 through instance #3 504-3 are accessed in parallel to form a 256-bit data bus for the first 0.5 MB of the memory bank, with each instance requiring 8 bits for ECC code. Similarly, the second half of the memory instances #4 504-4 through instance #7 504-7 are accessed in parallel to form a 256-bit data bus for the second 0.5 MB of the memory bank.

When an initiator uses less than 0.5 MB memory, the memory controller can reconfigure the bank in a 0.5 MB low-power mode 506 as shown at 501. For example, the instructions and data of a processor core may occupy less than 0.5 MB of memory while the firmware executing on the processor core implements and monitors the low-power state of the storage controller. As shown in FIG. 5 at 503, the memory controller can place instance #4 504-4 through instance #7 504-7 in a low-power state (e.g., deep sleep or off) while instance #0 504-0 through instance #3 504-3 remain active. In some cases, however, the amount of memory needed or used by an initiator may be less than 0.5 MB. Thus, in some aspects, the memory controller may implement an address map with a 0.125 MB low-power mode 508 in which individual instances of 0.125 MB are selectively configurable to place in low-power states.

To implement the 0.125 MB low-power mode 508, the memory controller can use a sequencer of the memory bank to switch the address mapping for the address space of four instances, instance #0 504-0 through instance #3 504-3, from a parallel mapping (256b) to a sequential mapping (64b) such that each instance 504 is individually accessible. Thus, as shown at 503, when less than 0.125 MB memory is needed, the memory controller can place all other instances of the memory banks in a low-power state. In other words, up to seven of the other instances 504 of the memory bank can be powered down to maximize power savings. This configurability of low-power mappings costs little in terms of area as each instance includes a same amount of memory in all power modes while the sequential access enables individual instances of the memory bank to be powered down. In sequential mode, access may be slower due to the 64-bit transfer width, however, in low-power states, lower performance is typically an acceptable tradeoff as the memory controller is often idle monitoring for wakeup notifications. Alternatively or additionally, the memory controller may include direct memory access (DMA) logic to enable data movements from the other 0.125 MB instances to instance #0, and vice versa, which may decrease transition times when entering or exiting the low-power modes.

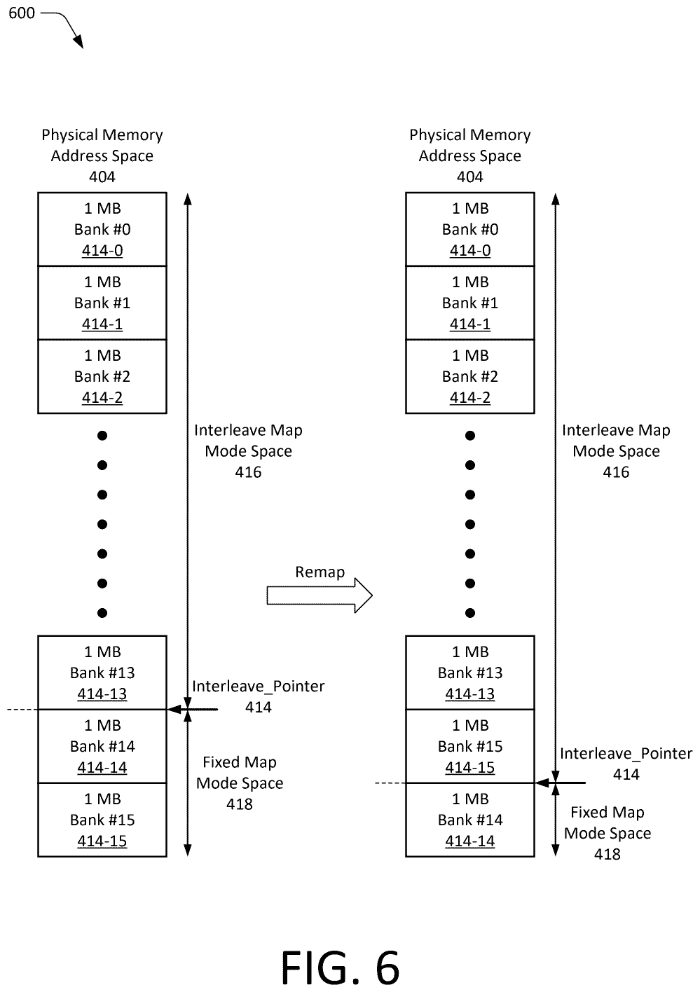

FIG. 6 illustrates at 600 an example of remapping a bank of memory without data movement in accordance with one or more aspects. Generally, the memory controller may implement a map mode pointer or any suitable address boundary to define regions of memory space with different respective mapping modes. After initial configuration, the memory controller may alter the map mode pointer to adjust the boundary of the IMM space and the FMM space. In various aspects of hybrid LTP address mapping, the bank remap logic of the memory controller may also remap a bank for memory effective to change a position of the bank within the physical memory address space. In the context of the physical memory address space 404 of FIG. 4, assume the memory controller or firmware of the storage controller initially configures or sets the interleave pointer 412 to 14. Thus, the memory controller configures banks #0 414-0 through #13 414-13 (14 banks) to support IMM and banks #14 414-14 and #15 414-15 to support FMM. During operation, the firmware may need to add another bank of memory to the IMM space to increase the amount of memory available for buffering data transferred between the host interface and storage media. To do so, the memory controller can adjust the interleave pointer to 15, which would move bank #14 414-14 to the IMM address space or configure bank #14 to support the IMM. Assume, however, that bank #14 414-14 is used to store data but bank #15 414-15 is not being used to store data. Instead of moving all the data from bank #14 414-14 to bank #15 414-15, the bank remap logic of the memory controller can remap bank #14 to bank #15 as shown in FIG. 6. The memory controller can implement this remapping on the fly, thereby saving power and reducing delay when the reconfiguration of the interleave pointer is implemented. When the firmware of the storage controller determines to revery back to the initial configuration of the interleave pointer, the memory controller can maintain the current remapping or swap the memory banks back ensuring no data movement between banks is necessary.

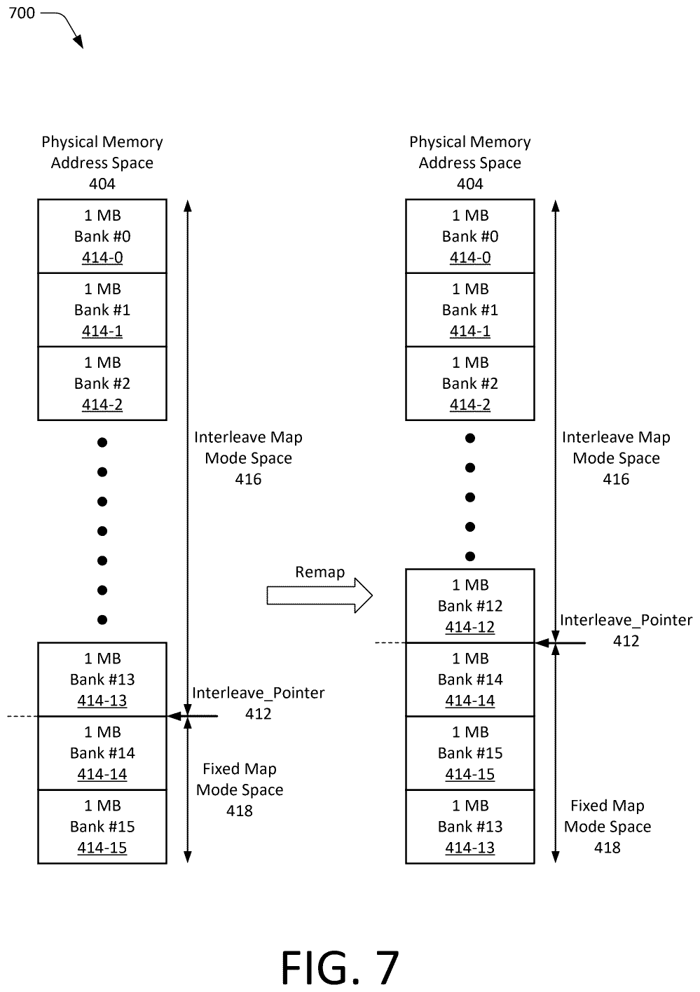

FIG. 7 illustrates at 700 an example another example of reconfiguring a map mode pointer to change a map mode of a bank of memory in accordance with one or more aspects. In contrast with the interleave pointer adjustment as described with reference to FIG. 6, assume that the firmware adjusts or sets the interleave pointer from 14 to 13, thereby moving bank #13 414-13 from the IMM space 416 to the FMM space 418. In some cases, the memory controller may forego bank remapping of bank #13 and the memory controller can store additional data to bank #13 using the FMM with the address range of D0_0000 to DF_FFFF. Alternatively, the memory controller can use the bank remap logic to remap bank #13 to bank #15 at the end of the physical memory address space. From the initiator's perspective, existing data of bank #14 and #15 will shift up by 1 MB and bank #13 will be remapped to address space F0_0000 to FF_FFFF. In either implementation, the memory controller does not need to migrate the data of bank #13 to use bank #13 in the FMM. When moving the interleave pointer to shift memory banks from the IMM to the FMM, however, the data of the interleave mode banks will no longer be valid and the memory controller may need to preserve that data as appropriate.

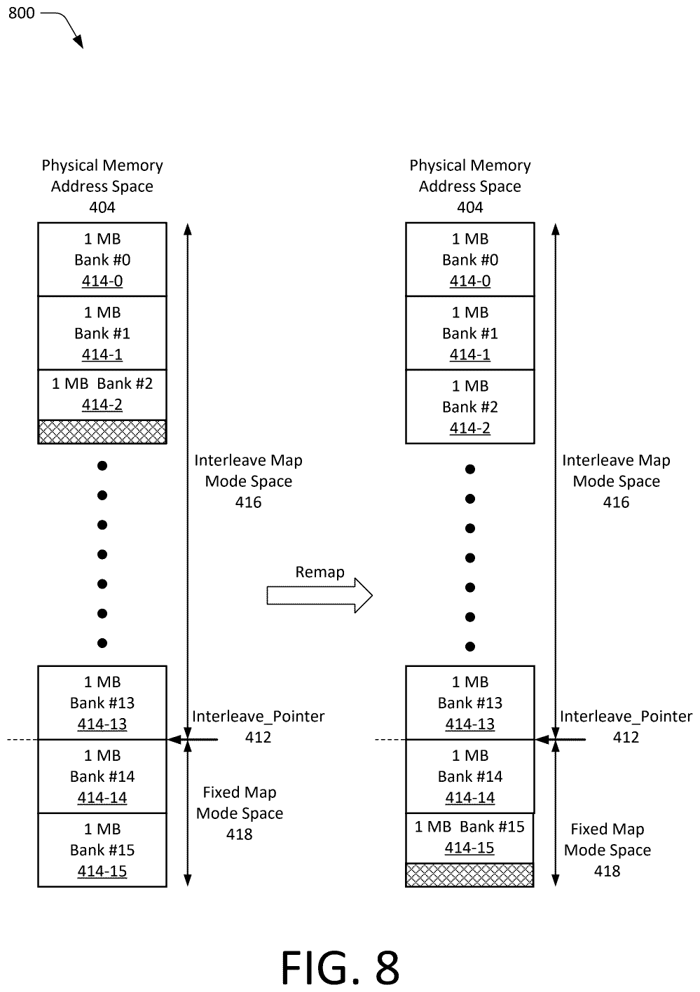

FIG. 8 illustrates at 800 an example of remapping a defective bank of interleave mapped memory with a FMM to enable continued use of the bank. In some implementations, the memory controller may use the scrubbing manager 312 to implement memory scrubbing to correct 1-bit errors and/or minimize the probability of 2-bit errors when implementing SECDEC. For example, the scrubbing manager 312 can implement patrol scrubbing while the memory system is idle and/or demand scrubbing through error correction performed when data is requested or transferred. When the scrubbing manager 312 identifies back-to-back 1-bit errors at the same location within a memory bank, the scrubbing manager can mark the bank as defective and notify the firmware and/or update a defect tracking lookup table.

As noted, when supporting IMM, all the interleave memory banks need to have the same capacity such that accesses can be distributed across the banks of the IMM space. By way of example, assume that the scrubbing manager or defect detector of the memory controller identifies a defect or persistent error at an offset of 0.75 MB in bank #2 414-2, which is configured to support the IMM. Instead of disabling bank #2 (marking it unused) and limiting the interleave operation to the remaining 13 interleave mode banks, the memory controller can use the bank remap logic to switch the roles of interleave mode bank #2 and bank #15 from the FMM region as shown in FIG. 8. With this remapping, the access performance of banks #0 through #13 remains the same and the firmware can update bank #2, now bank #15, to reflect a reduced capacity to enable continued operation in the FMM with a reduced 0.25 MB capacity, reduced from 1 MB due to the location of the defect. Thus, the memory controller can implement aspects of hybrid LTP address mapping and bank remapping to isolate defective areas of memory with minimal capacity loss.

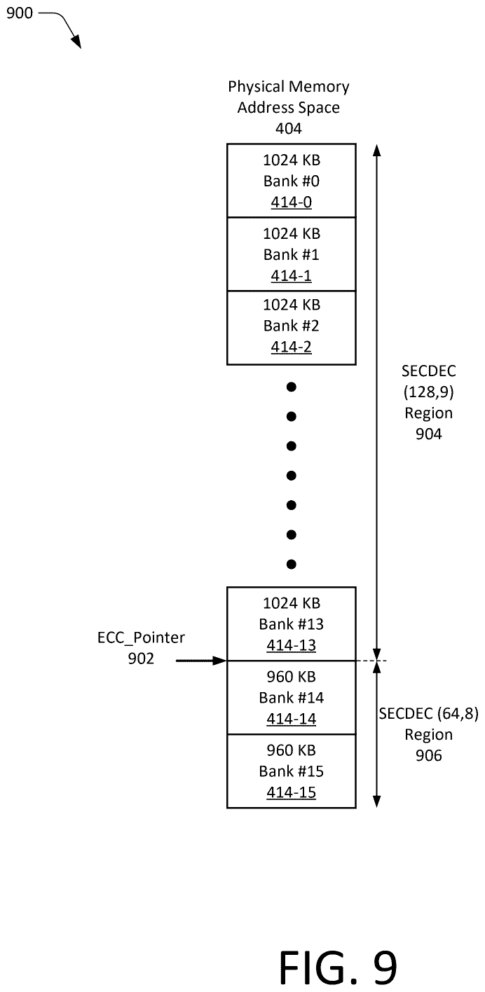

FIG. 9 illustrates at 900 an example illustrates an example implementation of configurable error detection and correction (EDAC) in accordance with various aspects. In aspects, the EDAC logic 138 of the memory controller 132 may be configured to implement different types of ECC, such as SECDEC, over different portions or regions of logical address space based on boundaries between the different ECC address spaces. As shown in FIG. 9, the memory controller can set or configure an ECC pointer 902 to define or separate address regions with different respective ECC or SECDEC settings. In this example, the ECC pointer 902 is set at 14 to configure the EDAC logic 138 to implement a first SECDEC (128,9) region 904 across banks #0 through bank #13 and a second SECDEC (64,8) region 906 across banks #14 and #15. Note that with the additional ECC bits of SECDEC (64,8) coding, the capacity of banks #14 and #15 is reduced to 960 KB whereas the capacity of banks #0 through bank #13 remains at 1024 KB with SECDEC (128,9) coding. In relation to the interleave pointer and associated map mode regions, the different mapping modes and different SECDEC configurations may align or overlap in accordance with various aspects of hybrid LTP address mapping. In other words, the interleave pointer and the ECC pointer may be set as the same or independently from one another.

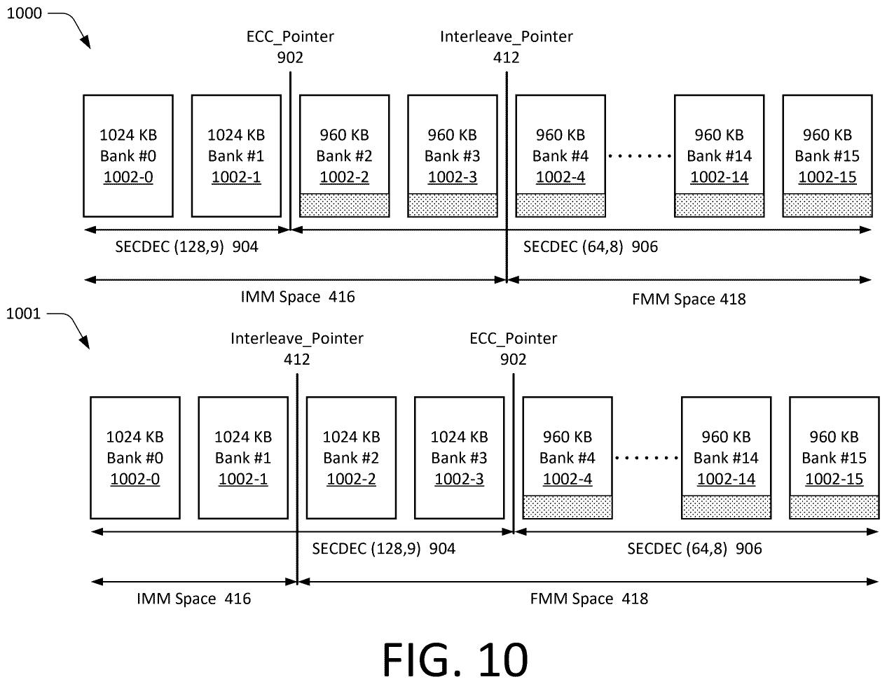

As an example of independent pointers, consider FIG. 10 which illustrates at 1000 and 1001 pointer configurations for implementing hybrid LTP address mapping with configurable EDAC in accordance with one or more aspects. As shown at 1000, the memory controller may set the ECC pointer 902 within the IMM space 416 such that the EDAC logic 138 performs SECDEC (128,9) for interleave mode banks #0 and #1 and performs SECDEC (64,8) for interleave mode banks #2 and #3 and the rest of banks #4 through #15, which are mapped with fixed mode mapping. Alternatively, the memory controller can set the ECC pointer 902 within the FMM space 418 such that the EDAC logic 138 performs SECDEC (128,9) for interleave mode banks #0 and #1 and fixed mode banks #2 and #3 and performs SECDEC (64,8) for the rest of the fixed mode banks #4 through #15. To implement address calculation while implementing hybrid physical to logical address mapping and configurable EDAC, the memory controller may calculate a bank select and bank offset for a given logical address (AXI_Addr) as shown in Equation 2 below.
Intl_Bound=Intl_P*960 KB+64 KB*MIN (Intl_P, ECC_P)
ECC_Bound=1 MB*ECC_P+96 0 KB*MAX (Intl_P-ECC_P, 0)
Intl Offset=960 KB*MAX (Intl_P-ECC_P, 0)
Fix Offset=64 KB*ECC_P
If (AXI_Addr<Intl_Bound):
   If (AXI_Addr<960 KB*Intl_P):
      (i) Bank Select=AXI_Addr MOD Intl_P
      Bank Offset=AXI_Addr DIV Intl_P
   Else:
      (ii) Bank Select=(AXI_Addr-Intl_Offset) MOD MIN (Intl_P, ECC_P); Bank Offset=(AXI_Addr-Intl_Offset)/MIN (Intl_P, ECC_P);
Else:
   If (AXI_Addr>=ECC_Bound):
      (iii) Bank Select=(AXI_Addr-Fix_Offset) DIV 960 KB;
      Bank Offset=(AXI_ADDR-Fix_Offset) MOD 960 KB;
   Else:
      (iv) Bank Select=AXI_Addr DIV 1 MB;
      Bank Offset=AXI_Addr MOD 1 MB;

### Equation 2: Address Calculation for Hybrid LTP and Configurable EDAC

As shown in Equation 2, prior to calculating addresses, the memory controller can determine respective boundaries and offsets useful for calculating the addresses for use in hybrid LTP address mapping and configurable EDAC. For example, the memory controller can determine an interleave boundary (Intl_Bound) based on the interleave pointer (Intl_P) multiplied by combined bank capacity (960 KB data, 64 KB ECC) then multiplied by the lower of the interleave pointer and the ECC pointer (ECC_P). The ECC boundary (ECC_Bound) can be determined based on bank size (1 MB) multiplied by the sum of the ECC pointer and bank data capacity (960 KB with SECDEC (64,8)) and then multiplied by the larger one of a difference between the interleave pointer and the ECC pointer or zero. The memory controller can also determine an interleave offset (Intl_Offset) based on the data capacity of the banks (960 KB) and the larger one of a difference between the interleave pointer and the ECC pointer or zero. A fixed offset (Fix_Offset) can be determined based on the memory capacity allocated to ECC bits (64 KB with SECDEC (64,8)) multiplied by the ECC pointer.

With the respective boundaries and offsets determined, the memory controller 132 can implement address calculations for the hybrid LTP address map 134 and the EDAC logic 138. As shown in Equation 2, when the initiator address (AXI_Addr) is less than the interleave boundary, the memory controller first compares the initiator address with the data capacity of the banks (960 KB) multiplied by the interleave pointer. When the initiator address is less than this, the memory controller determines (i) the bank select of the address as a result of initiator address modulo the interleave pointer and determines the bank offset with the division of the initiator address by the interleave pointer. If the initiator address is not less than the data capacity of the banks (960 KB) multiplied by the interleave pointer, the memory controller determines (ii) the bank select as the difference between the address and the interleave offset modulo the smaller of the interleave pointer or the ECC pointer. The bank offset can then be determined as the difference between the initiator address and the interleave offset divided by the smaller of the interleave pointer or the ECC pointer.

When the initiator address is not less than the interleave pointer, the calculation follows the primary Else path of equation 2. The memory controller compares the initiator address with the ECC boundary, and if the initiator address is greater than or equal to the ECC boundary, the memory controller determines (iii) the bank select as the difference between the address and the fixed offset divided by the bank data capacity (960 KB) and the bank offset as the difference between the initiator address and the fixed offset modulo the bank data capacity (960 KB). When the initiator address is less than the ECC boundary, the memory controller can determine the bank select as the initiator address divided by a size of the bank (1 MB) and the bank offset as the initiator address modulo the size of the bank. With respect to processing overhead, the calculations of Equation 2 can be implemented with negligible overhead on top of calculations used to support the configurable EDAC features. As such, the memory controller may implement an efficient formula for physical address calculation with implementing independent interleave and ECC pointers.

### Techniques for Hybrid LTP Address Mapping

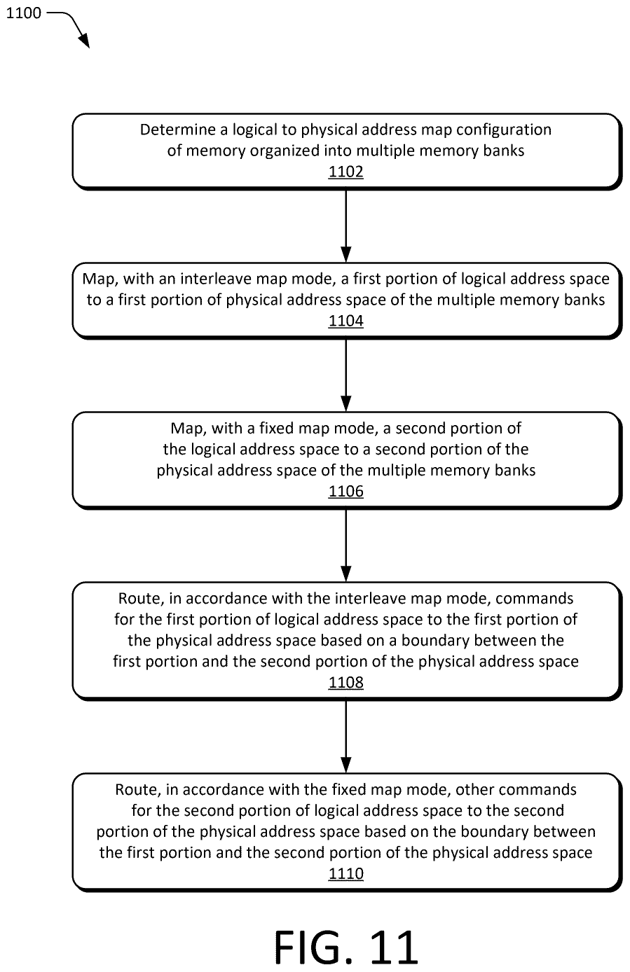

The following discussion describes techniques for hybrid LTP address mapping, which may map initiators or logical addresses to regions or banks of physical address space of a memory using multiple mapping modes. These techniques may be implemented using any of the environments and entities described herein, such as the memory controller 132, hybrid LTP address map 134, bank remap logic 136, and/or EDAC logic 138. These techniques include various methods illustrated in FIGS. 11-15, each of which is shown as a set of operations that may be performed by one or more entities.

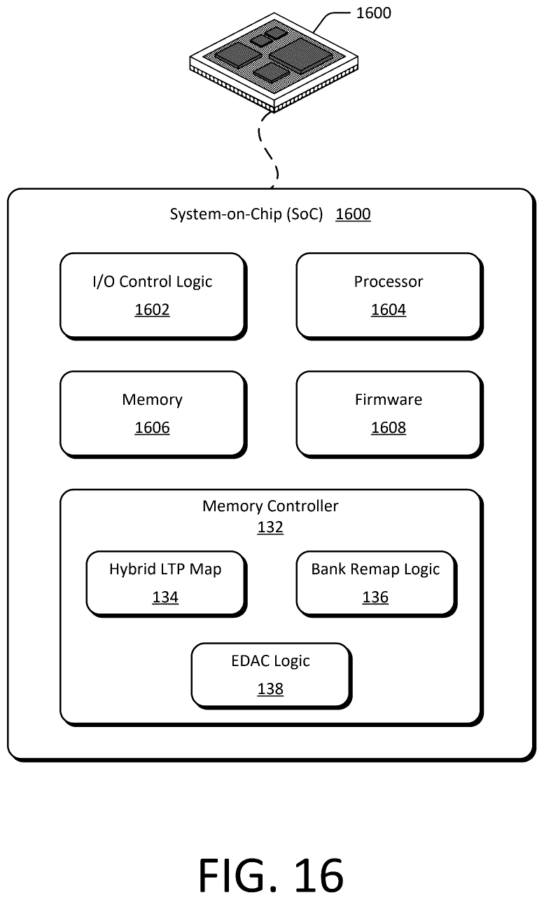

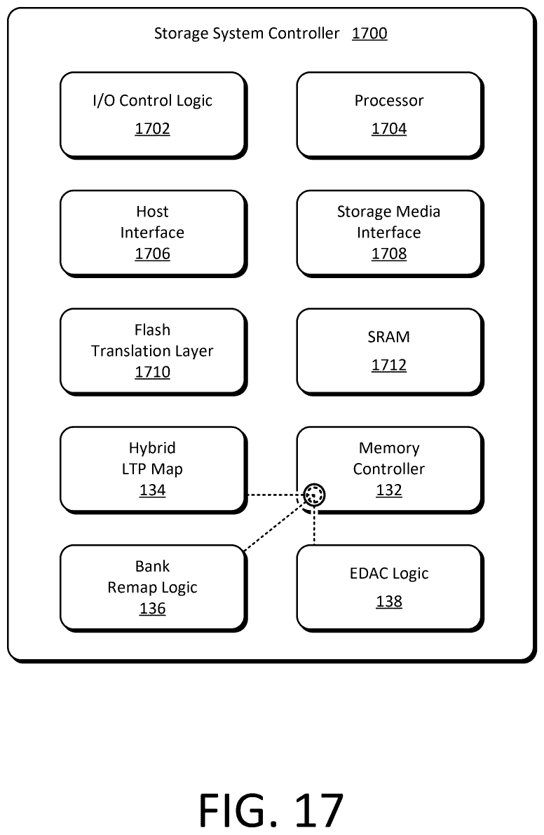

These methods are not necessarily limited to the orders of operations shown in the associated figures. Rather, any of the operations may be repeated, skipped, substituted, or re-ordered to implement various aspects described herein. Further, these methods may be used in conjunction with one another, in whole or in part, whether performed by the same entity, separate entities, or any combination thereof. For example, the methods may be combined to implement aspects of hybrid LTP address mapping to map, with an IMM, a first region of logical address space to a first subset of banks of a memory and map, with a FMM, a second region of the logical address space to a second subset of banks of the memory. Additionally, the methods may implement aspects related to remapping banks, implementing low-power mappings, and configurable EDAC in combination with the hybrid LTP address mapped memory. In portions of the following discussion, reference will be made to the operating environment 100 of FIG. 1 and various entities or configurations of FIGS. 2-10 by way of example. Such reference is not to be taken as limiting described aspects to the operating environment 100, entities, or configurations, but rather as illustrative of one of a variety of examples. Alternately or additionally, operations of the methods may also be implemented by or with entities described with reference to the System-on-Chip of FIG. 16 and/or the storage system controller of FIG. 17.

FIG. 11 depicts an example method 1100 for implementing hybrid LTP address mapping, including operations performed by or with the memory controller 132, firmware of the memory controller, and/or hybrid LTP address map 134.

At 1102, a memory controller determines a LTP address map configuration of a memory organized into multiple memory banks. The memory controller may receive, generate, or update the LTP address map. For example, the memory controller may determine an updated LTP address map in response to a subset of memory banks configured as a data buffer being over an occupancy threshold for a duration of time. Thus, the memory controller may determine an updated LTP address map to increase the banks available for buffering data. In some implementations, the memory controller sets a boundary between a first portion of physical address space configured with an IMM and a second portion of the physical address space configured with a FMM. To do so, the memory controller may set a value of a pointer (e.g., map mode pointer, interleave pointer) of a hybrid LTP address map that is useful for routing the commands to the memory banks in accordance with either map mode.

At 1104, the memory controller maps, with an IMM, a first portion of logical address space to a first portion of physical address space of the multiple memory banks. The first portion of the physical address space mapped with the IMM may align with a first subset of the multiple banks of the memory. In other words, the memory controller may use the interleave pointer to configure a first number of the memory banks to support the IMM.

At 1106, the memory controller maps, with a FMM, a second portion of the logical address space to a second portion of the physical address space of the multiple memory banks. The second portion of the physical address space mapped with the FMM may align with a second subset of the multiple banks of the memory. Similarly, the memory controller can use the interleave pointer to configure a second number of the memory banks to support the FMM.

At 1108, the memory controller routes, in accordance with the IMM, commands for the first portion of logical address space to the first portion of the physical address space based on a boundary between the first portion and the second portion of the physical address space. In some aspects, the memory controller determines a bank select value based on a logical address of the command and the value of the pointer using a modulo operation and determines a bank offset value based on the logical address of the command and the value of the pointer using a division operation. Based on the bank select value and the bank offset value, the memory controller can route the commands to the first portion of the physical address space that supports the IMM.

At 1110, the memory controller routes, in accordance with the fixed map mode, other commands for the second portion of logical address space to the second portion of the physical address space based on the boundary between the first portion and the second portion of the physical address space. In some aspects, the memory controller determines a bank select value and a bank offset value based on respective bit select operations. For example, the memory controller may implement the bit select operations of Equation 1 (of the Otherwise branch) to determine the bank select value and the bank offset value for routing the commands to the second portion of the physical address space that supports the FMM.

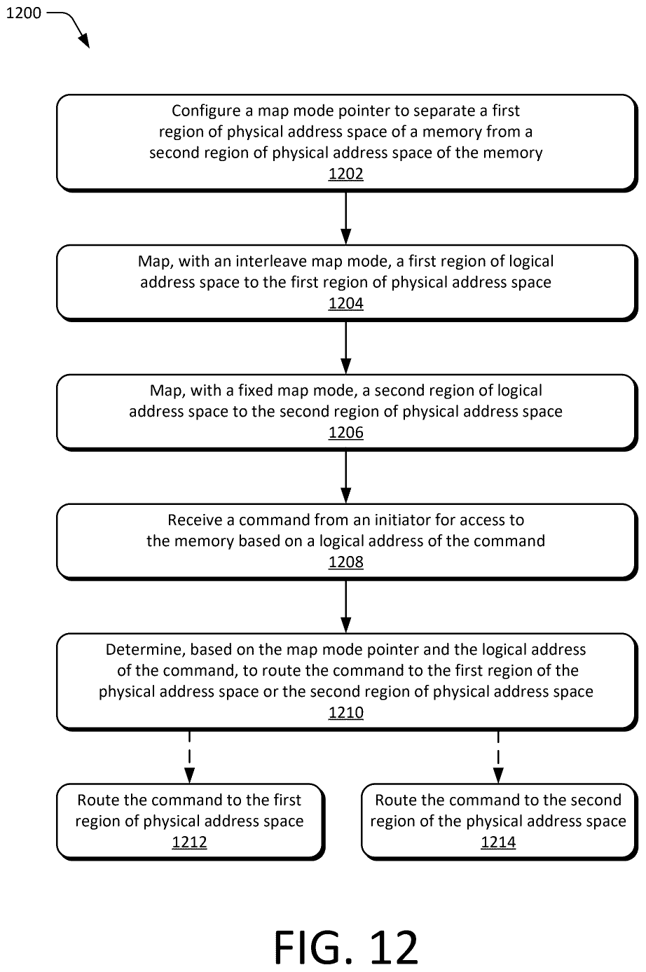

FIG. 12 depicts an example method 1200 for configuring regions of physical address space through different respective types of mapping modes, including operations performed by or with the memory controller 132, firmware of the memory controller, and/or hybrid LTP address map 134.

At 1202, the memory controller configures a map mode pointer to separate a first region of physical address space of a memory from a second region of physical address space of the memory. In some implementations, the memory controller configures or sets a value of a map mode pointer of a hybrid LTP address map in which logical address space is mapped with both interleave and fixed map modes.

At 1204, the memory controller maps, with an IMM, a first region of logical address space to the first region of physical address space. The first region of logical address space may be exposed to one or more initiators of a memory system. For example, the memory controller can expose or map the first logical address space (or associated AXI port) to a data transfer interface (e.g., NVMe endpoint), which can use memory banks of the first region of physical address space as a data buffer when transferring data.

At 1206, the memory controller maps, with a FMM, a second region of logical address space to the second region of physical address space. The second region of logical address space may be exposed to one or more initiators of the memory system. For example, the memory controller can expose or map the second logical address space (or associated AXI port) to a processor core of a storage controller, which can use a memory bank of the first region of physical address space to store code (e.g., firmware) and data of the processor.

At 1208, the memory controller receives a command from an initiator for access to the memory based on a logical address of the command. For example, an NVMe endpoint may send a command to access data stored in a memory bank that supports the IMM. Alternatively, the processor core may issue a command to retrieve data stored in a memory bank that supports the FMM. The address of the command may be formatted as an AXI address or logical address, which the memory controller can use to route the command based on the hybrid LTP address map.

At 1210, the memory controller determines, based on the map mode pointer and the logical address of the command, to route the command to the first region of the physical address space or the second region of physical address space. For example, the memory controller may determine a bank select value and a bank offset value using the value of the map mode pointer and the logical address of the command, such as the calculations described with reference to FIG. 4 or FIG. 10.

Optionally at 1212, the memory controller routes the command to the first region of physical address space based on the logical address of the command and the map mode pointer. In other words, the memory controller can route the command to a memory bank of the first region of physical address space that supports the IMM. Optionally at 1214, the memory controller routes the command to the second region of the physical address space based on the logical address of the command and the map mode pointer. Thus, the memory controller can route the command to a memory bank of the second region of physical address space that supports the FMM.

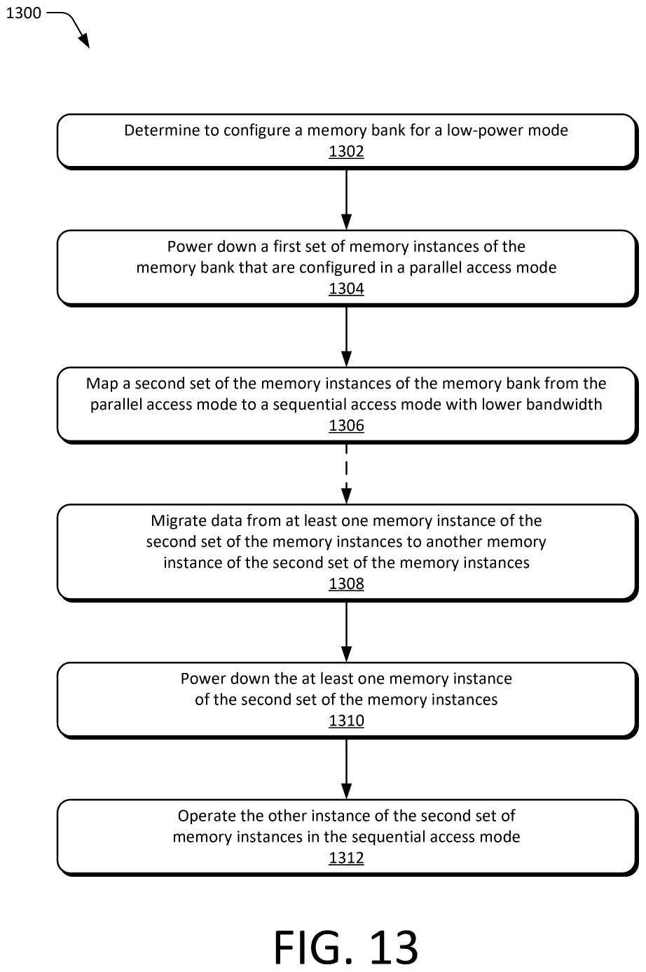

FIG. 13 depicts an example method 1300 for configuring instances of a memory bank for operation in a low-power mode, including operations performed by or with the memory controller 132, firmware of the memory controller, and/or hybrid LTP address map 134.

At 1302, the memory controller determines to configure a memory bank for a low-power mode. For example, when a storage system is idle, a storage controller or firmware of the storage system may command the memory controller to enter a low-power mode. Alternatively, the memory controller may determine to enter the low-power mode in response to an inactivity timer expiring without access to one or more banks of memory coupled with the memory controller. In some cases, the memory controller powers down a first subset of memory banks, such as a group of interleave memory banks that are inactive. Thus, the memory controller may leave one or more banks supporting a FMM operating because such banks can be powered down individually and/or partially to reduce power consumption.

At 1304, the memory controller powers down a first set of memory instances of the memory bank that are configured in a parallel access mode. In some cases, the memory controller powers down at least one bank mapped in FMM and leaves one bank mapped in fixed map mode operating. With respect to the one fixed mode bank left operating, the memory controller may power down a first set of memory instances configured to operate in the parallel access mode (e.g., instances 504-4 through 504-7).

At 1306, the memory controller maps a second set of the memory instances of the memory bank from the parallel access mode to a sequential access mode with lower bandwidth. In other words, the memory controller may reconfigure instances of the fixed mode bank from a parallel access mode (256-bit) to a sequential access mode (64-bit). In the context of FIG. 5, the memory controller reconfigures instances 504-0 through 504-3 from a parallel access mode to a sequential access mode.

Optionally at 1308, the memory controller migrates data from at least one memory instance of the second set of the memory instances to another memory instance of the second set of the memory instances. In other words, based on a number of the instances needed to maintain the data that shall remain accessible in the low-power state, the memory controller may migrate data from other instances to enable those instances to be powered down. For example, if only one 0.125 MB instance is needed to store code and data of a processor core, the memory controller or a DMA engine of the memory controller can migrate data from the other instances and those instances may be placed in the low-power state.

At 1310, the memory controller powers down at least one memory instance of the second set of the memory instances. As described herein, the memory controller may power down one or more instances based on an amount of memory needed to keep data accessible in the low-power state. Thus, the low-power mappings of the memory controller provide flexibility to maximize power savings when smaller amounts of memory need to be kept active. At 1312, the memory controller operates the other instances of the second set of memory instances in the sequential access mode. As described in reference to FIG. 5, the memory controller may keep one or more instances of the memory active, such as to support operations by the firmware of the storage controller while the rest of the memory is placed in the low-power state (e.g., deep sleep or shut down). By so doing, the memory controller can increase power savings with minimal cost increases in terms of complexity and design area.

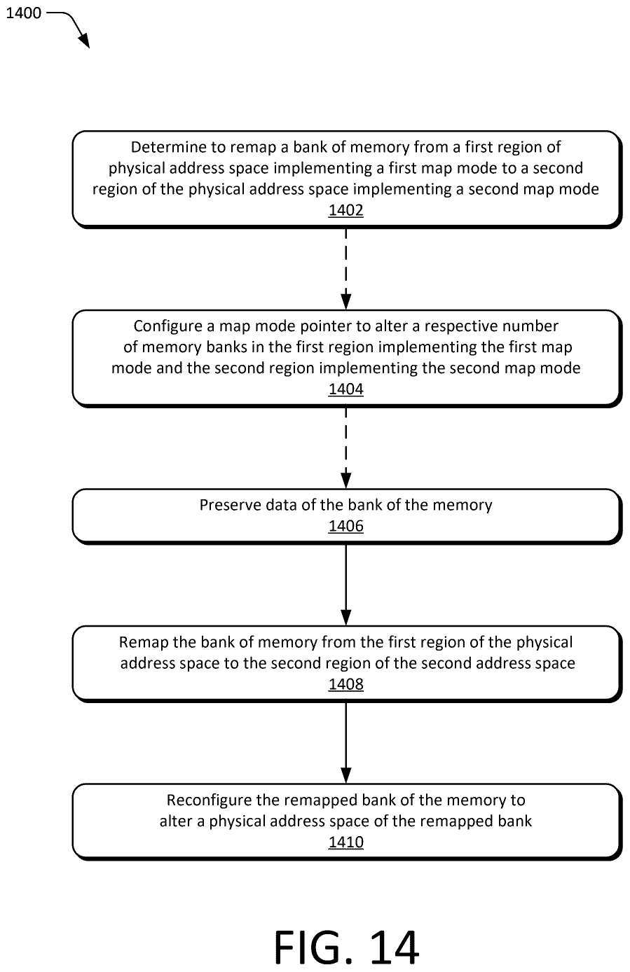

FIG. 14 depicts an example method 1400 for remapping a bank of memory with a different map mode, including operations performed by or with the memory controller 132, firmware of the memory controller, hybrid LTP address map 134, and/or bank remap logic 136.

At 1402, the memory controller determines to remap a bank of memory from a first region of physical address space implementing a first map mode to a second region of the physical address space implementing a second map mode. For example, the memory controller may determine that additional interleave memory is needed for data buffering or a defect has been detected in an interleave bank, which should be remapped to support the FMM.

Optionally at 1404, the memory controller configures a map mode pointer to alter a respective number of memory banks in the first region implementing the first map mode and the second region implementing the second map mode. In other words, the memory controller can alter the value of the pointer to change a number of banks in the first subset of the banks aligned with the first portion of physical address space mapped with the IMM and another number of banks in the second subset of the banks aligned with the second portion of physical address space mapped with the FMM.

Optionally at 1406, the memory controller preserves the data of the bank of the memory. In some cases, such as for interleave banks, the data stored in the bank may become invalid once the bank is remapped to a different logical address or to support FMM. Accordingly, the memory controller may back up the data of the bank and buffer the data, which can then be redistributed to the remaining interleave banks or written to another bank remapped into the IMM space. For example, when swapping a defective interleave bank for a fixed mode bank, the memory controller may back up the data and write it to the fixed mode bank once that bank is reconfigured to support the IMM.

At 1408, the bank remap logic of the memory controller remaps the bank of memory from the first region of the physical address space to the second region of the second address space. In some cases, the memory controller remaps a bank of the memory from the IMM to the FMM and/or remaps another bank of the memory from the FMM to the IMM. Thus, the memory controller can use the bank remap logic to swap banks having a same map mode (within a same map mode region) or swap the map modes of the banks (between map mode regions).

At 1410, the memory controller reconfigures the remapped bank of the memory to alter a physical address space of the remapped bank. For example, when an interleave bank is remapped as a fixed mode bank due to detection of a defect, the memory controller can adjust the capacity or logical mapping of the now-fixed mode bank to enable use of the remaining non-defective memory cells or memory area. Specifically, the memory controller can alter an available physical address range of or offset into the bank to prevent access to the location within the bank that is defective.

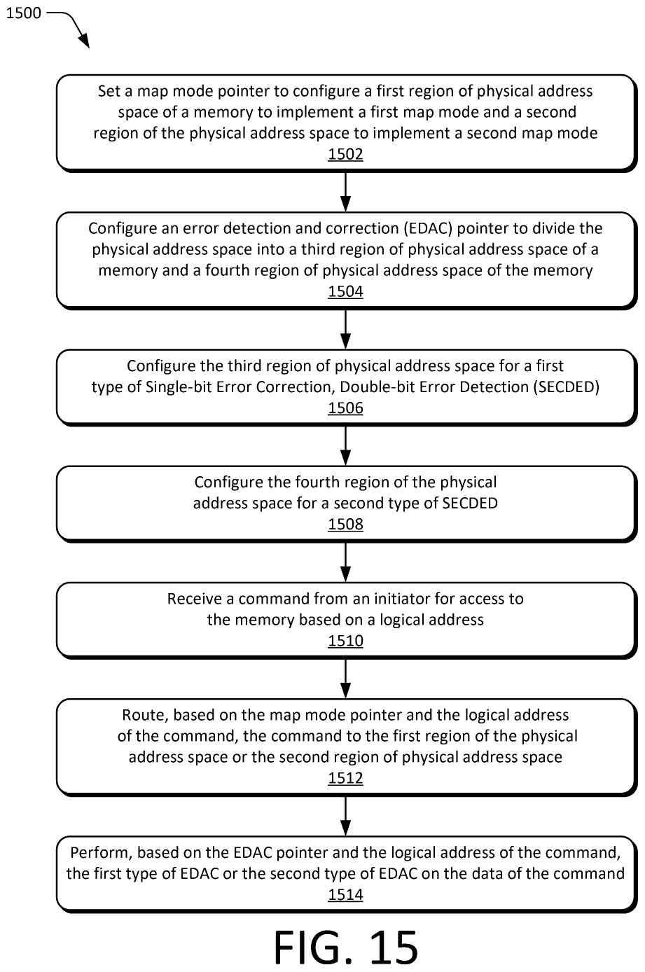

FIG. 15 depicts an example method for implementing configurable EDAC in a memory address space implemented through multiple map modes, including operations performed by or with the memory controller 132, firmware of the memory controller, hybrid LTP address map 134, and/or EDAC logic 138.

At 1502, the memory controller sets a map mode pointer to configure a first region of physical address space of a memory to implement a first map mode and a second region of the physical address space to implement a second map mode. For example, the memory controller can set the value of an interleave pointer to configure a first subset of memory banks to support IMM and a second subset of the memory banks to support FMM.

At 1504, the memory controller configures an EDAC pointer to divide the physical address space into a third region of physical address space of a memory and a fourth region of physical address space of the memory. The memory controller may include EDAC logic capable of implementing multiple types or levels of error correction, which may be implemented in conjunction with a defect detector and/or scrubbing logic of the memory controller.

At 1506, the memory controller configures the third region of physical address space for a first type of SECDED operation. For example, as described in reference to FIG. 10, the EDAC logic of the memory controller may be configured to implement SECDED (128,9) over the third region of physical address space. At 1508, the memory controller configures the fourth region of the physical address space for a second type of SECDED operation. For example, as described in reference to FIG. 10, the EDAC logic of the memory controller may be configured to implement SECDED (64,8) over the fourth region of physical address space.

At 1510, the memory controller receives a command from an initiator for access to the memory based on a logical address of the command. For example, an NVMe endpoint may send a command to access data stored in a memory bank that supports the IMM. Alternatively, the processor core may issue a command to retrieve data stored in a memory bank that supports the FMM. The address of the command may be formatted as an AXI address or logical address, which the memory controller can use to route the command based on the hybrid LTP address map.

At 1512, the memory controller routes, based on the map mode pointer and the logical address of the command, the command to the first region of the physical address space or the second region of physical address space. As described with reference to the methods 1100 and 1200, the memory controller can route the command to an interleave mode bank or a fixed mode bank based on the logical address and the map mode pointer (e.g., interleave pointer).

At 1514, the EDAC logic performs, based on the EDAC pointer and the logical address of the command, the first type of EDAC or the second type of EDAC on the data of the command. In some aspects, the EDAC logic may determine to perform a first type of SECDED based on the ECC pointer, ECC boundary, and/or calculations described in reference to FIG. 10 and Equation 2. For example, the EDAC logic can perform SECDED (128,9) for data accessed from the third region of physical address space. Alternatively, the EDAC logic can perform SECDED (64,8) for data accessed from the fourth region of physical address space.

### System-on-Chip and Controller

FIG. 16 illustrates an example System-on-Chip (SoC) 1600 environment in which various aspects of hybrid LTP address mapping may be implemented. The SoC 1600 may be implemented in any suitable system or device, such as a smart-phone, netbook, tablet computer, access point, network-attached storage, camera, smart appliance, printer, set-top box, server, solid-state drive (SSD), hard disk drive (HDD), storage drive array, memory module, automotive computing system, aggregate storage controller, or any other suitable type of device (e.g., others described herein). Although described with reference to a SoC, the entities of FIG. 16 may also be implemented as other types of integrated circuits or embedded systems, such as an application-specific integrated-circuit (ASIC), memory controller, storage controller, communication controller, application-specific standard product (ASSP), digital signal processor (DSP), programmable SoC (PSoC), system-in-package (SiP), or field-programmable gate array (FPGA).

The SoC 1600 may be integrated with electronic circuitry, a microprocessor, memory, input-output (I/O) control logic, communication interfaces, firmware, and/or software useful to provide functionalities of a computing device, host system, or storage system, such as any of the devices or components described herein (e.g., storage drive or storage array). The SoC 1600 may also include an integrated data bus or interconnect fabric (not shown) that couples the various components of the SoC for control signaling, data communication, and/or routing between the components. The integrated data bus, interconnect fabric, or other components of the SoC 1600 may be exposed or accessed through an external port, parallel data interface, serial data interface, fabric-based interface, peripheral component interface, or any other suitable data interface. For example, the components of the SoC 1600 may access or control external storage media, machine-learning controllers, neural networks, datasets, or AI models, through an external interface or off-chip data interface.

In this example, the SoC 1600 includes various components such as input-output (I/O) control logic 1602 and a hardware-based processor 1604 (processor 1604), such as a microprocessor, processor core, application processor, DSP, or the like. The SoC 1600 also includes memory 1606, which may include any type and/or combination of RAM, SRAM, DRAM, non-volatile memory, ROM, one-time programmable (OTP) memory, multiple-time programmable (MTP) memory, Flash memory, and/or other suitable electronic data storage. In some aspects, the processor 1604 and code stored on the memory 1606 are implemented as a storage system controller, storage aggregator, or storage accelerator to provide various functionalities associated with hybrid LTP address mapping. In the context of this disclosure, the memory 1606 stores data, code, instructions, or other information via non-transitory signals, and does not include carrier waves or transitory signals. Alternately or additionally, SoC 1600 may comprise a data interface (not shown) for accessing additional or expandable off-chip storage media, such as solid-state memory (e.g., Flash or NAND memory), magnetic-based memory media, or optical-based memory media.

The SoC 1600 may also include firmware 1608, applications, programs, software, and/or operating system, which may be embodied as processor-executable instructions maintained on the memory 1606 for execution by the processor 1604 to implement functionalities of the SoC 1600. The SoC 1600 may also include other communication interfaces, such as a transceiver interface for controlling or communicating with components of a local on-chip (not shown) or off-chip communication transceiver. Alternately or additionally, the transceiver interface may also include or implement a signal interface to communicate radio frequency (RF), intermediate frequency (IF), or baseband frequency signals off-chip to facilitate wired or wireless communication through transceivers, physical layer transceivers (PHYs), or media access controllers (MACs) coupled to the SoC 1600. For example, the SoC 1600 may include a transceiver interface configured to enable storage over a wired or wireless network, such as to provide a network attached storage (NAS) volume with hybrid LTP address mapping.

In various implementations, the SoC 1600 also includes instances of a memory controller 132, hybrid LTP address map 134, bank remap logic 136, and EDAC logic 138, which may be implemented separately as shown or combined with a storage component, host controller, data interface, or accessible through an off-chip interface (e.g., neural networks stored in external memory). In accordance with various aspects of hybrid LTP address mapping, the memory controller may configure the hybrid LTP address map 134 to map, with an IMM, a first region of logical address space to a first subset of banks of a memory and map, with a FMM, a second region of the logical address space to a second subset of banks of the memory. Additionally, the memory controller 132 may implement aspects related to remapping banks, implementing low-power mappings, and configurable EDAC in combination with the hybrid LTP address mapped memory. By so doing, the memory controller 132 can leverage benefits provided by either mapping mode to optimize access performance, reduce power consumption, or isolate defective areas with minimal capacity loss. Any of these entities may be embodied as disparate or combined components, as described with reference to various aspects presented herein. Examples of these components and/or entities, or corresponding functionality, are described with reference to the respective components or entities of the environment 100 of FIG. 1 or respective configurations illustrated in FIG. 2 through FIG. 10, and/or the methods of FIGS. 11-15. The memory controller 132, hybrid LTP address map 134, bank remap logic 136, and EDAC logic 138, either in whole or part, may be implemented as processor-executable instructions maintained by the memory 1606 and executed by the processor 1604 to implement various aspects and/or features of hybrid LTP address mapping.

The memory controller 132, hybrid LTP address map 134, bank remap logic 136, and EDAC logic 138 may be implemented independently or in combination with any suitable component or circuitry to implement aspects described herein. For example, the memory controller 132 and hybrid LTP address map 134 may be implemented as part of a DSP, processor/storage bridge, I/O bridge, graphics processing unit, memory controller, storage controller, arithmetic logic unit (ALU), or the like. The memory controller 132 and associated mapping and logic may also be provided integral with other entities of SoC 1600, such as integrated with the processor 1604, memory 1606, a storage media interface, or firmware 1608 of the SoC 1600. Alternately or additionally, the memory controller 132, hybrid LTP address map 134, bank remap logic 136, and EDAC logic 138, and/or other components of the SoC 1600 may be implemented as hardware, firmware, fixed logic circuitry, or any combination thereof.

As another example, consider FIG. 17 which illustrates an example storage system controller 1700 in accordance with one or more aspects of hybrid LTP address mapping. In various aspects, the storage system controller 1700 or any combination of components thereof may be implemented as a storage drive controller, distributed storage center controller (e.g., among a host and SSDs), storage media controller, NAS controller, Fabric interface, NVMe target, or storage aggregation controller for solid-state storage media. In some cases, the storage system controller 1700 is implemented similarly to or with components of the SoC 1600 as described with reference to FIG. 16. In other words, an instance of the SoC 1600 may be configured as a storage system controller, such as the storage system controller 1700, to manage solid-state (e.g., NAND Flash-based) media with in internal memory managed in accordance with aspects of hybrid LTP address mapping.

As shown in FIG. 17, the storage system controller 1700 includes input-output (I/O) control logic 1702 and a processor 1704, such as a microprocessor, processor core, application processor, DSP, or the like. In some aspects, the processor 1704 and firmware of the storage system controller 1700 may be implemented to provide various functionalities associated with hybrid LTP address mapping, such as those described with reference to any of methods 1100 through 1500. The storage system controller 1700 also includes a host interface 1706 (e.g., SATA, PCIe, NVMe, or Fabric interface) and a storage media interface 1708 (e.g., NAND interface), which enable access to a host system and storage media, respectively. In this example, the storage system controller 1700 also includes a Flash translation layer 1710 (FTL 1710), SRAM 1712, and a memory controller 132 configured to enable access to the SRAM 1712. The memory controller 132 may include or implement instances of a hybrid LTP address map 134, bank remap logic 136, and EDAC logic 138. Any or all of these components may be implemented separately as shown or combined with the processor 1704, host interface 1706, storage media interface 1708, Flash translation layer 1710, and/or SRAM 1712. Examples of these components and/or entities, or corresponding functionality, are described with reference to the respective components or entities of the environment 100 of FIG. 1 or respective configurations illustrated in FIG. 2 through FIG. 10. In accordance with various aspects of hybrid LTP address mapping, the memory controller may configure the hybrid LTP address map 134 to map, with an IMM, a first region of logical address space to a first subset of banks of a memory and map, with a FMM, a second region of the logical address space to a second subset of banks of the memory. Additionally, the memory controller 132 may implement aspects related to remapping banks, implementing low-power mappings, and configurable EDAC in combination with the hybrid LTP address mapped memory. By so doing, the memory controller 132 can leverage benefits provided by either mapping mode to optimize access performance, reduce power consumption, or isolate defective areas with minimal capacity loss. The memory controller 132, either in whole or part, may be implemented as processor-executable instructions (e.g., firmware) maintained by memory of the controller and executed by the processor 1704 to implement various aspects and/or features of hybrid LTP address mapping.

Although the subject matter of hybrid LTP address mapping has been described in language specific to structural features and/or methodological operations, it is to be understood that the subject matter defined in the appended claims is not necessarily limited to the specific examples, features, or operations described herein, including orders in which they are performed.

What is claimed is:

1. A method for configuring logical to physical mapping of a memory comprising multiple banks, the method comprising:
mapping, with an interleave map mode, a first portion of logical address space to a first portion of physical address space of the multiple banks of the memory;
mapping, with a fixed map mode, a second portion of the logical address space to a second portion of the physical address space of the multiple banks of the memory;
routing, in accordance with the interleave map mode, commands for the first portion of the logical address space to the first portion of the physical address space based on a boundary between the first portion of the physical address space and the second portion of the physical address space; and
routing, in accordance with the fixed map mode, other commands for the second portion of the logical address space to the second portion of the physical address space based on the boundary between the first portion of the physical address space and the second portion of the physical address space.

2. The method of claim 1, further comprising:
determining a logical to physical address map configuration for the multiple banks of the memory; and
setting the boundary between the first portion of the physical address space and the second portion of the physical address space.

3. The method of claim 2, wherein setting the boundary between the first portion of the physical address space and the second portion of the physical address space comprises setting a value of a pointer that is useful for routing the commands or the other commands.

4. The method of claim 3, wherein routing one of the commands comprises:
determining a bank select value based on a logical address of the command and the value of the pointer using a modulo operation; and
determining a bank offset value based on the logical address of the command and the value of the pointer using a division operation.

5. The method of claim 3, wherein:
the first portion of the physical address space mapped with the interleave map mode aligns with a first subset of the multiple banks of the memory; and
the second portion of the physical address space mapped with the fixed map mode aligns with a second subset of the multiple banks of the memory.

6. The method of claim 5, further comprising:
powering down the first subset of the multiple banks aligned with the first portion of the physical address space mapped with the interleave map mode; and
powering down at least one bank of the second subset of the multiple banks aligned with the second portion of the physical address space mapped with the fixed map mode.

7. The method of claim 6, wherein the at least one bank of the second subset of the multiple banks comprises a first bank of the second subset of the multiple banks, and the method further comprises:
reconfiguring instances of a second bank of the second subset of the multiple banks from a parallel access mode to a sequential access mode; and
powering down at least one of the instances of the second bank that is reconfigured to the sequential access mode.

8. The method of claim 5, further comprising:
altering the value of the pointer to change a number of banks in the first subset of the banks aligned with the first portion of physical address space mapped with the interleave map mode and another number of banks in the second subset of the banks aligned with the second portion of physical address space mapped with the fixed map mode.

9. The method of claim 8, further comprising:
remapping a bank of the memory from the first portion of the physical address space mapped with the interleave map mode to the second portion of the physical address space mapped with the fixed map mode; or
remapping another bank of the memory from the second portion of the physical address space mapped with the fixed map mode to the first portion of the physical address space mapped with the interleave map mode.

10. The method of claim 9, wherein:
the bank of the memory is remapped to the second portion of the physical address space mapped with the fixed map mode in response to determining that a location within the bank is defective, and the method further comprises:
altering an available physical address range of the bank to prevent access to the location within the bank that is defective.

11. The method of claim 1, further comprising:
dividing the physical address space of the multiple banks of the memory into a third portion of the physical address space and a fourth portion of the physical address space;
configuring the third portion of the physical address space for a first type of error and data correction;
configuring the fourth portion of the physical address space for a second type of error and data correction; and
performing, based on the logical address of a command, the first type of error and data correction or the second type of error and data correction on data of the command.

12. An apparatus configured to implement hybrid logical to physical memory mapping, the apparatus comprising:
a host interface configured for communication with a host;
a media interface configured to enable access to storage media;
a processor core configured to execute instructions to manage transfers of data of the host between the host interface and the media interface;
a memory configured to store the data of the host and data of the processor core; and
a memory controller configured to:
map, with an interleave map mode, a first portion of logical address space exposed to the host interface and the processor core to a first portion of physical address space of multiple banks of the memory;
map, with a fixed map mode, a second portion of the logical address space exposed to the host interface and the processor core to a second portion of the physical address space of the multiple banks of the memory;
route, in accordance with the interleave map mode, commands for the first portion of the logical address space to the first portion of the physical address space based on a boundary between the first portion of the physical address space and the second portion of the physical address space; and
route, in accordance with the fixed map mode, other commands for the second portion of the logical address space to the second portion of the physical address space based on the boundary between the first portion of the physical address space and the second portion of the physical address space.

13. The apparatus of claim 12, wherein the memory controller is further configured to implement a pointer that defines the boundary between the first portion of the physical address space and the second portion of the physical address space of the multiple banks of the memory.

14. The apparatus of claim 12, wherein the memory controller is further configured to:
power down a first subset of the multiple banks of the memory aligned with the first portion of the physical address space mapped with the interleave map mode; and
power down at least one bank of a second subset of the multiple banks of the memory aligned with the second portion of the physical address space mapped with the fixed map mode.

15. The apparatus of claim 12, further comprising bank remap logic configured to:
remap a bank of the multiple banks of the memory from the first portion of the physical address space mapped with the interleave map mode to the second portion of the physical address space mapped with the fixed map mode; or
remap another bank of the multiple banks of the memory from the second portion of the physical address space mapped with the fixed map mode to the first portion of the physical address space mapped with the interleave map mode.

16. The apparatus of claim 12, further comprising error detection and correction logic configured to:
divide the physical address space of the multiple banks of the memory into a third portion of the physical address space and a fourth portion of the physical address space;
configure the third portion of the physical address space for a first type of error and data correction;
configure the fourth portion of the physical address space for a second type of error and data correction; and
perform, based on the logical address of a command, the first type of error and data correction or the second type of error and data correction on data of the command.

17. A System-on-Chip (SoC) configured to implement hybrid logical to physical memory mapping, the SoC comprising:
a component configured to implement a function of the SoC;
a processor core configured to execute instructions to manage operation of the SoC;
a memory system comprising:
a first port configured to enable communication with the processor;
a second port configured to enable communication with the component;
a memory configured to store data of the component and data of the processor core; and
a memory controller configured to:
configure a map mode pointer to separate a first region of physical address space of the memory from a second region of physical address space of the memory;
map, with an interleave map mode, a first portion of logical address space exposed to the first port and the second port to the first region of physical address space of the memory;
map, with a fixed map mode, a second portion of the logical address space exposed to the first port and the second port to the second region of the physical address space of the memory;
receive a command from the component via the first port or from the processor core via the second port for access to the memory based on a logical address;
determine, based on the map mode pointer and the logical address of the command, to route the command to the first region of the physical address space or the second region of the physical address space; and
route the command to the first region of the physical address space of the memory; or
route the command to the second region of the physical address space of the memory.

18. The SoC of claim 17, wherein the memory controller is further configured to:
power down a first subset of banks of the memory aligned with the first region of the physical address space mapped with the interleave map mode; and
power down at least one bank of a second subset of the banks of the memory aligned with the second portion of the physical address space mapped with the fixed map mode.

19. The SoC of claim 17, further comprising bank remap logic configured to:
remap a bank of the memory from the first region of the physical address space mapped with the interleave map mode to the second region of the physical address space mapped with the fixed map mode; or
remap another bank of the memory from the second region of the physical address space mapped with the fixed map mode to the first region of the physical address space mapped with the interleave map mode.

20. The SoC of claim 19, further comprising error detection and correction logic configured to:
divide the physical address space of the memory into a third region of the physical address space and a fourth region of the physical address space;
configure the third region of the physical address space for a first type of error and data correction;
configure the fourth region of the physical address space for a second type of error and data correction; and
perform, based on the logical address of the command, the first type of error and data correction or the second type of error and data correction on data of the command.
